(19) United States
(12) Patent Application Publication
(10) Pub. No.: US 2026/0025687 A1
(43) Pub. Date: Jan. 22, 2026

(54) Methods and System for Exploiting Channel Effects

(71) Applicant: InterDigital Patent Holdings, Inc., Wilmington, DE (US)

(72) Inventors: Kyle Jung-Lin Pan, Saint James, NY (US); Guodong Zhang, Woodbury, NY (US); Sudhir Pattar, Mount Laurel, NJ (US)

(73) Assignee: InterDigital Patent Holdings, Inc., Wilmington, DE (US)

(21) Appl. No.: 18/778,634

(22) Filed: Jul. 19, 2024

(51) Int. Cl. H04W 24/10; H04B 7/06; H04L 5/00

(52) U.S. Cl. CPC H04W 24/10; H04B 7/0626; H04L 5/0005

(57) ABSTRACT

A wireless transmit/receive unit (WTRU) may receive channel hardening (CH) measurement configuration information and/or CH reporting configuration information. The CH measurement configuration information may include one or more of a set of reference signals, a CH metric, one or more parameters associated with the CH metric, and/or one or more thresholds associated with the CH metric. The CH reporting configuration information may include a reporting period, one or more sub-bands to report, and/or whether the CH report is to include the CH condition over a narrow-beam and/or a wide-beam. The WTRU may determine whether a CH condition has occurred, for example, based on one or more measurements and/or based on the CH measurement configuration information. The WTRU may send a CH report. The CH report may include an indication of whether the CH condition has occurred. The WTRU may apply a transmission and/or a reception format associated with CH condition.

### BACKGROUND

The DL channel (and/or uplink, sidelink channel) at each subcarrier and/or resource element (RE) may be compensated through DL precoding (and/or uplink, sidelink precoding) before the transmission, the effective channel impulse response (CIR) could reduce to a single tap and give rise to a (e.g., large) coherence bandwidth (CB), and/or the flat channel becomes deterministic with respect to small variations in MIMO-orthogonal frequency-division multiplexing (OFDM) systems. With channel hardening, the (effective) channel gain may become predictable and/or deterministic. During CH, the antenna gain could be significant (e.g., large), and/or frequency could be flat. CH may provide stronger (e.g., better) reception performance.

### SUMMARY

A wireless transmit/receive unit (WTRU) may receive channel hardening (CH) measurement configuration information and/or CH reporting configuration information. The CH measurement configuration information may include one or more of a set of reference signals, a CH metric (e.g., effective channel gain, effective delay spread), one or more parameters associated with the CH metric, and/or one or more thresholds associated with the CH metric. The CH reporting configuration information may include one or more of a reporting period (e.g., periodicity, duration), one or more (e.g., a number of) sub-bands to report, and/or whether the CH report is to include the CH condition over a narrow-beam and/or a wide-beam. The WTRU may determine whether a CH condition has occurred, for example, based on one or more measurements and/or based on the CH measurement configuration information. The WTRU may send a CH report based on the CH reporting configuration information. The CH report may include an indication of whether the CH condition has occurred. The WTRU may apply a transmission and/or a reception format associated with CH condition.

The CH report may be sent based on a determination that the CH condition meets a criterion associated with the CH metric, the one or more parameters associated with the CH metric, and/or the one or more thresholds associated with the CH metric. The WTRU may receive a set of transmission and/or reception configuration information associated with the CH condition. The set of transmission or reception configuration may include one or more of a set of data channel configurations, a set of control channel configuration, a set data channel formats, and/or channel state information (CSI) reporting configuration information.

On a condition that the WTRU is configured with an autonomous mode, the WTRU may autonomously activate one or more reception or transmission configurations, included in the set of reception and/or transmission configuration information, for one or more subsequent receptions and/or transmissions. On a condition that the WTRU is not configured with the autonomous mode, the WTRU may send an indication of supported one or more reception and/or transmission configurations to a network node. The WTRU may apply a network-indicated reception and/or transmission configuration based on an indication by the network node.

The WTRU may measure one or more variations of channel gains using a CH metric to determine the one or more measurements. The WTRU may measure coherence bandwidth and/or delay spread to determine the one or more measurements.

The reporting configuration may indicate that the CH report should be sent via one or more of a medium access control (MAC) control element (CE), a layer one (L1) signaling message, a radio resource control (RRC) message, a sidelink (SL) MAC-CE, a SL-L1 signaling message, and/or a SL-RRC message. The CH report may include one or more of: the determined CH condition for each configured sub-band, and/or the determined CH condition of the measured wideband or narrow-band. For example, the CH report may include the CH condition(s) of one or more measured widebands and/or one or more measured narrow-bands.

The CH condition may include a positive CH condition and/or a negative CH condition. The transmission format may include a first transmission format and/or a second transmission format. The reception format may include a first reception format and/or a second transmission format. The WTRU may apply the first transmission and/or the first reception format based at least on the positive CH condition. The WTRU may apply the second transmission or the second reception format based at least on the negative CH condition.

The WTRU may reduce a demodulation reference signal (DM-RS) density, associated with time and/or frequency, based on a determination that the CH condition includes the positive CH condition. The WTRU may apply a first set of one or more search spaces based on the positive CH condition. The WTRU may apply a second set of one or more search spaces based on the negative CH condition.

The determination of the CH condition may be based on a CH metric. The CH metric may include an effective delay spread and/or an effective channel gain. The CH condition may be based on a deviation of the effective channel gain in accordance with the CH measurement configuration information and/or the CH condition may based on a determination that the effective delay spread is less than a threshold (e.g., included in the CH measurement configuration information).

The positive CH condition may include the effective delay spread and/or effective channel gain, in a time domain and/or a frequency domain, below the threshold (e.g., included in the CH measurement configuration information). The negative CH condition may include the effective delay spread and/or the effective channel gain, in the time domain and/or the frequency domain, equal to or greater than a threshold (e.g., included in the CH measurement configuration information).

Sending the CH report may include sending an indication that the CH condition has changed. The WTRU may send the CH report aperiodically based on one or more of layer 2 (L2)-medium access control (MAC) control entity (CE), radio resource control (RRC), and/or downlink control information (DCI). The CH report may be sent during a configured periodic and/or semi-persistent time window and/or duration.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example of a channel hardening (CH) detection in a measurement window with a (e.g., configured) measurement bandwidth (BW).

FIG. 3A depicts an example of a periodic L1-reference signal received power (RSRP) and CH report, where the CH report is every 160 ms

FIG. 3B depicts an example of a periodic L1-RSRP and CH report, where the L1-RSRP report is every 40 ms and the CH report is every 160 ms (e.g., CH measurement window).

FIG. 4 depicts an example of a CH L1 CH measurement with sliding CH measurement window.

FIG. 5 depicts an example of L1 CH measurements for radio resource control (RRC) CH event.

FIG. 6 depicts an example of a CH event and triggering mechanism based on L3.

FIG. 7 depicts an exemplary aperiodic channel state information (CSI) CH report.

FIG. 8 depicts an example of a reduced demodulated reference signal (DM-RS) density for a DM-RS configuration type (e.g., type 3 or 4).

FIG. 9 depicts an example flow diagram for (e.g., general) wireless transmit/receive unit (WTRU) methods and/or procedures for CH.

FIG. 10 depicts an example flow diagram for methods and/or procedures for WTRU autonomous CH mode.

FIG. 11 depicts an example of a distributed multiple input multiple output (MIMO) sidelink (SL) operations and/or methods for transmit (Tx) WTRU and receive (Rx) WTRU.

FIG. 12 depicts an example flow diagram for WTRU procedure for DM-RS density reduction when channel is hardening.

FIG. 13 depicts an example flow diagram for aperiodic trigger-based with L2 medium access control (MAC) control element (CE) for CH.

FIGS. 14A and 14B depict WTRU methods and/or procedures for SL CH mode.

### DETAILED DESCRIPTION

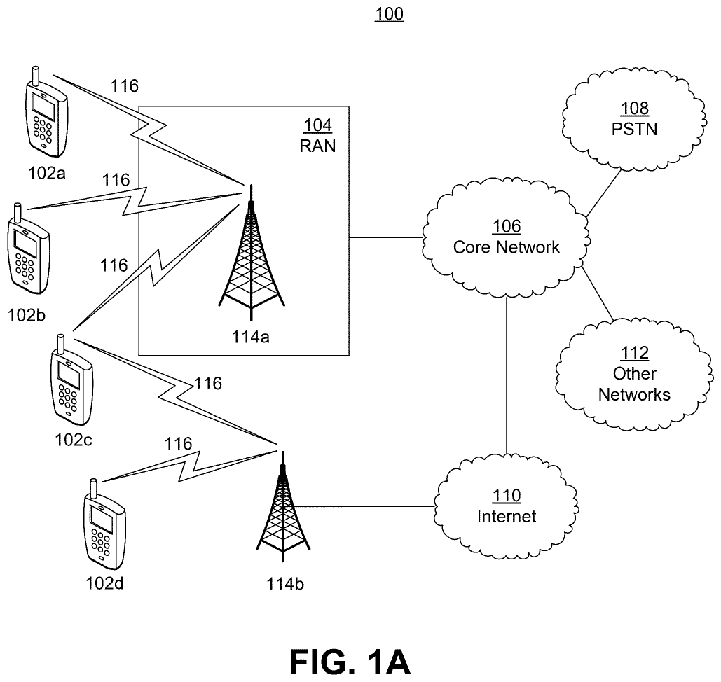

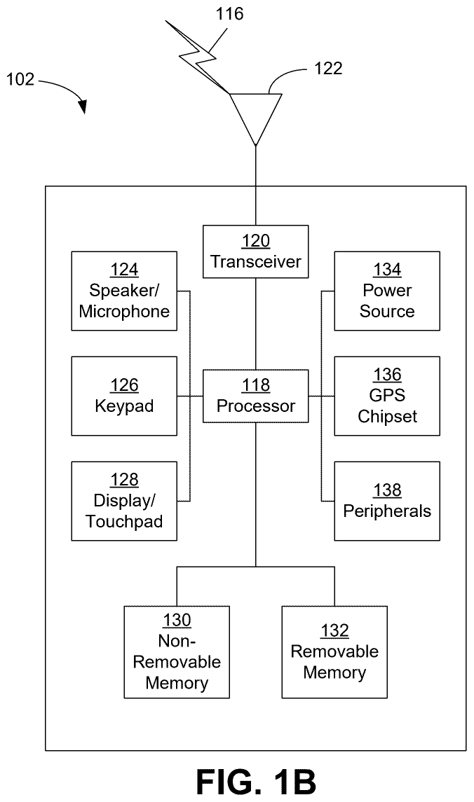

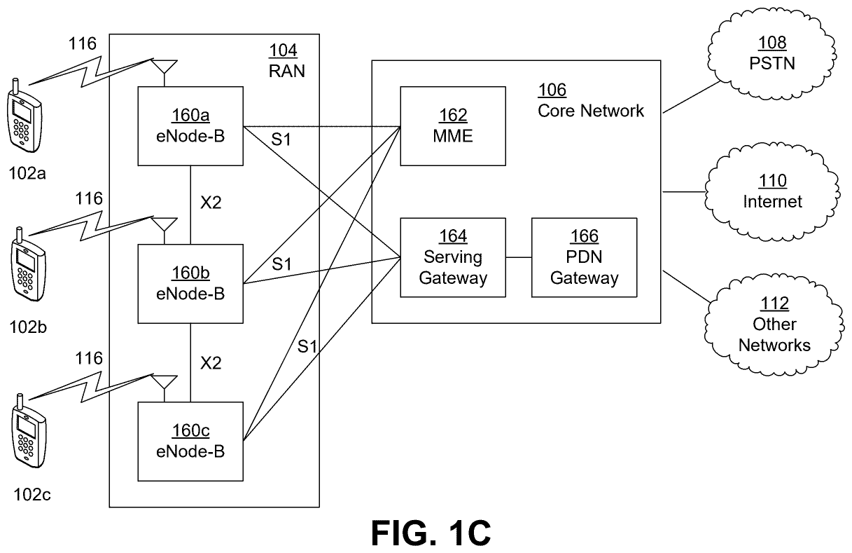

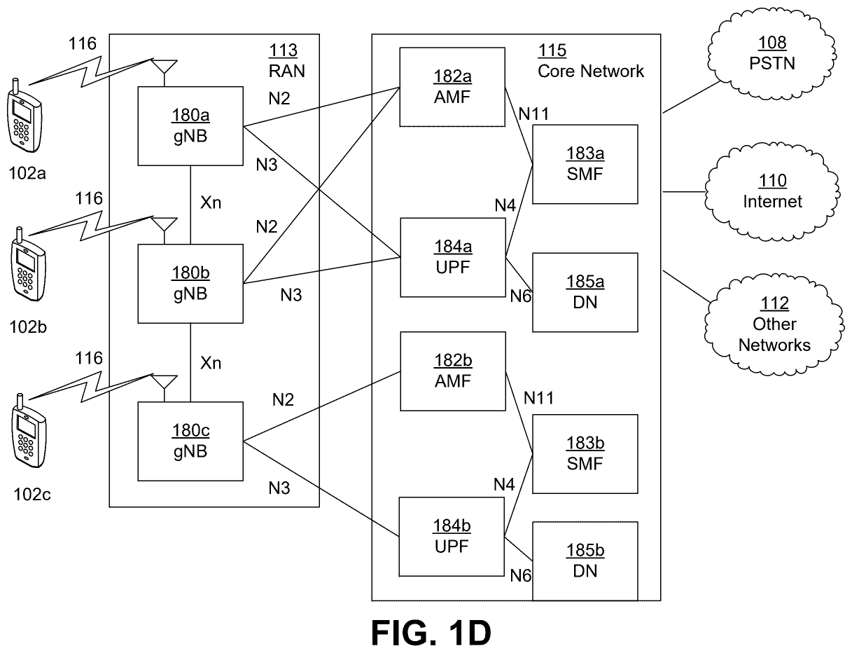

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as

Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL)Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A wireless transmit/receive unit (WTRU) may detect that the measured channel hardening (CH) condition(s) that meet a criterion (e.g., configured threshold). The WTRU may determine the measured CH conditions, for example, according to the CH measurement and/or reporting configuration. The WTRU may report and/or apply a transmission configuration associated to a CH condition, for example, based on detecting CH conditions on the downlink (DL) and/or sidelink (SL) using a configured CH measurement and/or reporting configuration. The WTRU may indicate the supported reception and/or transmission configuration to the network, and/or autonomously activate the supported reception and/or transmission configuration to a subsequent reception and/or transmission.

Channel hardening (CH) may be a phenomenon in which the channel behaves as almost fully deterministic as the number of antennas increases. When CH occurs, the effective channel becomes hardened and/or can be modeled as a single tap—e.g., frequency flat. Since the condition may associated to the deployment with large number of antennas, the channel hardening condition may last for a certain period of time. In massive MIMO (M-MIMO) system, when the number of antennas is (e.g., very) large, the effective channel fluctuations decrease, the effective channel gain may be getting hard. As the (e.g., wireless) channel becomes more hard, less fluctuation and/or variation of channel gain may occur. Channel hardening may occur when narrow beams are applied. When deploying narrow beams, parts of the scatters may not be illuminated, channel delay spread might decrease, and/or the (e.g., overall) channel response may look flat. In CH, the effective channel gain can be described and/or predicted by the (e.g., large) scaling fading effect instead of (e.g., small) fading effect. In the frequency domain, channel hardening may be regarded as flat fading of the effective channel over a (e.g., large) bandwidth. In the time domain, the channel hardening may imply that the strong contributions of the effective channel impulse response (CIR) are confined to a single delay tap, with reliable tap power for one or more (e.g., most) realizations. When the channel is hardened, the channel may become more deterministic, therefore channel estimation and/or equalization could be simplified (e.g. a single gain value). This phenomenon can be exploited and/or utilized in a wireless system, for example, to enable more efficient system operations (e.g., such as by reducing the number of reference symbols needed for channel estimation and/or demodulation).

NR (e.g., 3GPP 5G NR) may not provide (e.g., any) means to measure CH conditions directly and/or efficiently. While it could be possible for gNB (and/or a transmission (Tx) node, Tx WTRU) to infer CH conditions, for example, by observing no variation in successive channel state information (CSI) reports, on its own it may reflect static channel conditions (e.g. signal to noise ratio (SNR)), but not necessarily CH conditions (e.g., constant channel gain). Additionally or alternatively, the network (and/or Tx node, a Tx WTRU) could exploit CH directly by adapting the number of reference symbols (e.g. demodulated reference signal (DMRS), sounding reference signal (SRS), CSI-reference signal (RS), sidelink (SL)-CSI-RS, etc.) sent on the downlink (DL), uplink (UL), and/or sidelink (SL). The drawback may be that the network would have to blindly determine whether the formats are suitable and/or not for the channel. This may result in inefficiency and/or could result in, for example, a significant (e.g., large) number of retransmissions when the format has insufficient number of reference symbols for the current channel condition. To enhance the wireless systems, one or more (e.g., two) of the problems may be addressed. A first problem may regard how can the WTRU detect and/or report efficiently CH conditions. Additionally or alternatively, a second problem may be that once CH condition is detected and reported, how can the transmission formats be adapted efficiently according to the detected and reported CH conditions by the WTRU.

Embodiments described herein may related to channel hardening measurement, reporting, and/or resulting WTRU actions. A WTRU may report and/or apply a transmission configuration associated to a CH condition, for example, based on detecting CH condition(s) on the DL (and/or SL) using a configured CH measurement and/or reporting configuration.

A WTRU may receive a CH measurement and/or reporting configuration. For example, a WTRU may receive CH measurement configuration information and/or CH reporting configuration information. CH measurement and/or reporting configuration may include one or more of the following. CH measurement and/or reporting configuration may include a set of RS (e.g., CSI-RS, synchronization signal block (SSB), SL-CSI-RS, SL-SSB, etc.). CH measurement and/or reporting configuration may include CH metric to use and/or associated parameters (e.g., measurement duration, sub-band segmentation configuration, one or more widebands and/or one or more narrow-bands configuration(s), etc.). CH measurement and/or reporting configuration may include one or more thresholds (e.g., for triggering WTRU actions, reporting, etc.). CH measurement and/or reporting configuration may include reporting configuration (e.g., reporting period, number of sub-band(s) to report, one or more narrow-bands and/or one or more widebands, etc.). The reporting period may include periodicity (e.g., periodic, aperiodic, and/or semi-persistent) configuration and/or a duration (e.g., configuration associated with a duration). The CH measurement configuration information may include one or more of a set of reference signals, a CH metric (e.g., effective channel gain, effective delay spread), and/or one or more thresholds associated with the CH metric. For example, the CH measurement configuration information may include one or more CH metrics (e.g., the effective channel gain and/or the effective delay spread). The reporting configuration information may include one or more of a reporting period (e.g., periodicity, duration), one or more (e.g., a number of) sub-bands to report, and/or whether the CH report is to include the CH condition over one or more narrow-beams and/or one or more wide-beams.

A WTRU may receive a set of reception and/or transmission configurations associated with CH conditions. The set of reception and/or transmission configurations associated with CH conditions may include one or more of the following. The set of reception and/or transmission configurations associated with CH conditions may include a set of data channel (e.g., physical uplink shared channel (PUSCH), physical sidelink shared channel (PSSCH)) configurations (e.g., formats with different DMRS and/or SL-DMRS symbols configuration). The set of reception and/or transmission configurations associated with CH conditions may include a set of control channel (e.g., physical downlink control channel (PDCCH)/search space, physical uplink control channel (PUCCH)). For example, the set of control channel may include synchronization signal (SS) configuration enabling different DMRS configuration for downlink control information (DCI), aggregation level, configuration enabling different SL-DMRS configuration for sidelink control information (SCI), etc. The set of reception and/or transmission configurations associated with CH conditions may include a set of data channel (e.g., physical downlink shared channel (PDSCH), physical sidelink shared channel (PSSCH) configurations and/or formats. The set of reception and/or transmission configurations associated with CH conditions may include CSI, SL-CSI reporting configuration (e.g., different periodicities). A WTRU may apply a first set of one or more search spaces based on a positive CH condition and/or apply a second set of one or more search spaces based on a negative CH condition. The positive CH condition may include the effective delay spread and/or the effective channel gain, in a time domain and/or a frequency domain, below a threshold (e.g., included in the CH measurement configuration information). The negative CH condition may include the effective channel gain and/or the effective delay spread, in a time and/or a frequency domain, equal to and/or greater than a threshold (e.g., included in the CH measurement configuration information).

A WTRU may determine whether a CH condition has occurred. The WTRU may determine whether the CH condition has occurred based on one or more measurements and/or based on the CH measurement configuration information. The determination of the CH condition may be based on a CH metric. The CH metric may include an effective delay spread and/or an effective channel gain. The CH condition may be based on a deviation of the effective channel gain in accordance with the CH measurement configuration information. The CH condition may be based on a determination that the effective delay spread is less than one or more thresholds (e.g., included in the CH measurement configuration information). For example, one or more thresholds may be (pre) configured and/or (pre) defined (e.g., one or more thresholds may be dynamically configurable for flexibility purposes). A WTRU may determine the measured CH conditions according to the CH measurement and/or reporting configuration. For example, the WTRU may measure variations of channel gains using the CH metric over the configured measurement duration, for the number of configured sub-band, and/or over the one or more widebands and/or one or more narrowbands, according to the configuration. The WTRU may measure coherence bandwidth and/or delay spread and/or the like, for example, according to the configuration.

A WTRU may perform (e.g., unconditional) reporting. For example, a WTRU may report the measured CH condition according to the reporting configuration. The WTRU may send the CH report based on the CH reporting configuration. Sending the CH report may include sending an indication that the CH condition has changed. The CH report may include an indication of whether the CH condition has occurred. The WTRU may report the measured CH condition for each sub-band configured. The WTRU may report the measured CH condition of the measured wideband. The WTRU may report, for example, MAC-CE/L1/RRC, SL-MAC-CE/SL-L1/SL-RRC. The WTRU may report in control channel, data channel, and/or feedback channel (e.g., PUCCH/PUSCH, PSCCH/PSSCH/physical sidelink feedback channel (PSFCH), etc.). For example, the reporting configuration may indicate that the CH report should be sent via one or more of a medium access control (MAC) control element (CE), a layer one (L1) signaling message, a radio resource control (RRC) message, a sidelink (SL) MAC-CE, a SL-L1 signaling message, and/or a SL-RRC message. The CH report may include one or more of: the determined CH condition for each configured sub-band, and/or the determined CH condition of the measured wideband(s) and/or narrow-band(s). For example, the CH report may include the CH condition(s) of one or more measured widebands and/or one or more measured narrow-bands.

A WTRU may detect that the measured CH condition meet a criterion (e.g., configured threshold) and/or may perform one or more of the following. A WTRU may report the detected measured CH condition (e.g., using MAC-CE/L1/RRC, SL-MAC-CE/SL-L1/SL-RRC.). For example, the CH report may be sent based on a determination that the CH condition meets a criterion associated with the CH metric, the one or more parameters associated with the CH metric, and/or the one or more thresholds associated with the CH metric. The WTRU may determine the supported reception and/or transmission configuration based on the detected measured CH conditions according to the reception and/or transmission configuration. The WTRU may indicate the supported reception/transmission configuration to the network. The WTRU may (e.g., autonomously) activate the supported reception and/or transmission configuration to a subsequent reception and/or transmission (e.g., after a configured duration). The WTRU may apply a network-indicated reception and/or transmission configuration based on (e.g., after reception of) an (e.g., explicit) indication by the network.

The WTRU may apply a transmission and/or a reception format associated with the CH condition (e.g., as described herein).

Channel hardening may be considered when one or more of the conditions are observed. Channel hardening may be considered when the variance of effective channel gain of each resource block (RB) and/or subband over a measurement bandwidth (BW) and a measurement time window is below a (e.g., small) threshold. Effective channel gain of one or more (e.g., all) RBs is flat in frequency domain is significantly (e.g., very) close to the mean of the effective channel gain [symbol] {g} over a time period. Channel hardening may be considered when the (e.g., effective) channel delay spread is decreased, which means that the fading over frequency becomes small.

The DL channel (and/or uplink, sidelink channel) at each subcarrier and/or resource element (RE) may be compensated through DL precoding (and/or uplink, sidelink precoding) before the transmission, the effective channel impulse response (CIR) could reduce to a single tap and give rise to a (e.g., large) coherence bandwidth (CB), and/or the flat channel becomes deterministic with respect to small variations in MIMO-orthogonal frequency-division multiplexing (OFDM) systems. With channel hardening, the (effective) channel gain may become predictable and/or deterministic. During CH, the antenna gain could be significant (e.g., large), and/or channel gain in frequency could be flat. CH may provide stronger (e.g., better) reception performance.

The WTRU may detect and/or report efficiently CH conditions to the gNB (or Tx node, a Tx WTRU). For example, a WTRU may detect the effective channel gain being flat across a BW. Additionally or alternatively, the WTRU may detect the effective delay spread is smaller than a threshold across a BW. Once CH condition is detected, for example, the transmission formats may be adapted according to the detected CH conditions. Dynamic adaptation of transmission format based on detected CH conditions may be performed. This may be performed by (e.g., either) the WTRU and/or the gNB, and/or jointly determined by both WTRU and gNB. If format adaptation is performed and/or determined by WTRU, the decision may be fed back to gNB and/or received the acknowledge and/or indication from gNB. If format adaptation is performed and/or determined at the gNB, the gNB may indicate the determined format to the WTRU. In case of sidelink, for example, the WTRU and/or the gNB may be replaced by transmission WTRU and/or reception WTRU. For example, DM-RS density may be reduced and/or more PDSCH symbols may be utilized for transmission. CSI-RS density may also be decreased. The RS overhead may be reduced and/or more PDSCH symbols may be utilized for transmission. Search space or search space set group (SSSG) where the number of PDCCH candidates and/or aggregation levels (ALs) may (e.g., also) be reduced, and/or search space switching may be performed based on the detected CH condition. A WTRU may apply a first set of one or more search spaces based on a positive CH condition and/or apply a second set of one or more search spaces based on a negative CH condition.

Embodiments described herein may relate to channel hardening measurements. A WTRU may be configured with channel hardening measurement configurations. The WTRU may be configured via higher layer signaling (e.g., RRC signaling) with a CH measurement for performing CH detection. The configuration may include one or more of the following. The configuration may include measurement objects: RS(s) (e.g., CSI-RS, SSB, SL-CSI-RS, SL-SSB may be configured as CH-RS); for example, 20 ms (P-RS) if periodic CSI. The configuration may include the number of antenna ports (e.g., N) used for calculating the effective CH. The configuration may include the measurement window. The measurement window may indicate one or more (e.g., the number of) RS samples WTRU needs to estimate; if the measurement window is not specified then it may be up to WTRU to determine the measurement. The configuration may include the measurement BW. The WTRU may be configured with a single measurement BW and/or SL-BW (wideband) and/or one or more (e.g., multiple) measurement BWs and/or SL-BWs (subbands). The maximum CH measurement BW may be equal to bandwidth part (BWP) BW and/or SL-BWP BW. The CH measurement BW may be one report per configured measurement BW so that subband reporting (e.g., one report per configured subband) is supported. When CH report is with other CSI report type like L1-RSRP, SL-L1-RSRP, then this measurement BW can be the same with other CSI report type.

Channel hardening detection may be described herein. Channel hardening detection may refer to measuring the effective channel gain over a measurement BW, e.g., examine the condition where the maximum deviation of each RB instantaneous effective channel gain at a OFDM symbol is within X or Y dB (e.g. X=0.5, Y=1) relative with effective channel gain in the measurement BW. Channel hardening detection may refer to measuring the small-fading parameters such as the effective delay spread/delay spread and/or determining if it is smaller than a threshold. For example, when the number of antenna ports for CH measurement is based on one/single port (e.g., deploying narrow beam), when part of the scatters is not illuminated, the channel delay spread might be significantly reduced, and/or the (e.g., overall) channel response might look flat. In this case, CH may be detected.

For example, CH detection using the effective channel gain may be demonstrated as following procedures.

A WTRU may measure the effective channel gain g from each RS (e.g. CSI-RS) resources in a time period (e.g. in a monitoring window and/or BW). A WTRU may calculate each RB effective channel gain gain g_{k,l} where K is the total number of RBs in a measurement BW and l-th OFDM symbol. A WTRU may calculate the average of the effective channel across L RS in time and/or a measurement BW, e.g.,

$$\frac{1}{KL} {\sum }_{k = 0}^{K - 1} {\sum }_{i = 0}^{L - 1} {‖ {H}_{k , l + iP} ‖}^{2} = 𝔼 \{ g \} .$$

For example, if the number of antenna ports is (relatively) large, e.g., the number of antenna ports needs to detect/explore CH condition exceeds a certain number e.g. >100, the WTRU may perform CH measurement and/or detection based on calculating the effective channel from one or more (e.g., all) antenna ports.

A WTRU may determine the CH detection/occurrence to examine the condition where the maximum deviation of each RB instantaneous effective channel gain at the OFDM symbol l+(L-1)P, e.g., g_{k,l+(L-1)P} is within X or Y dB (e.g. X=0.5, Y=1) relative with [symbol] {g} in the measurement BW, e.g., |g_{k,l+(L-1)P} [dB]− [symbol] {g}[dB]|<X or Y, k∈0 . . . K˜1. If one of the conditions is true, e.g., |g_{k,l+(L-1)P} [dB]− [symbol] {g}[dB]|<X or Y for one or more (e.g., all) k.

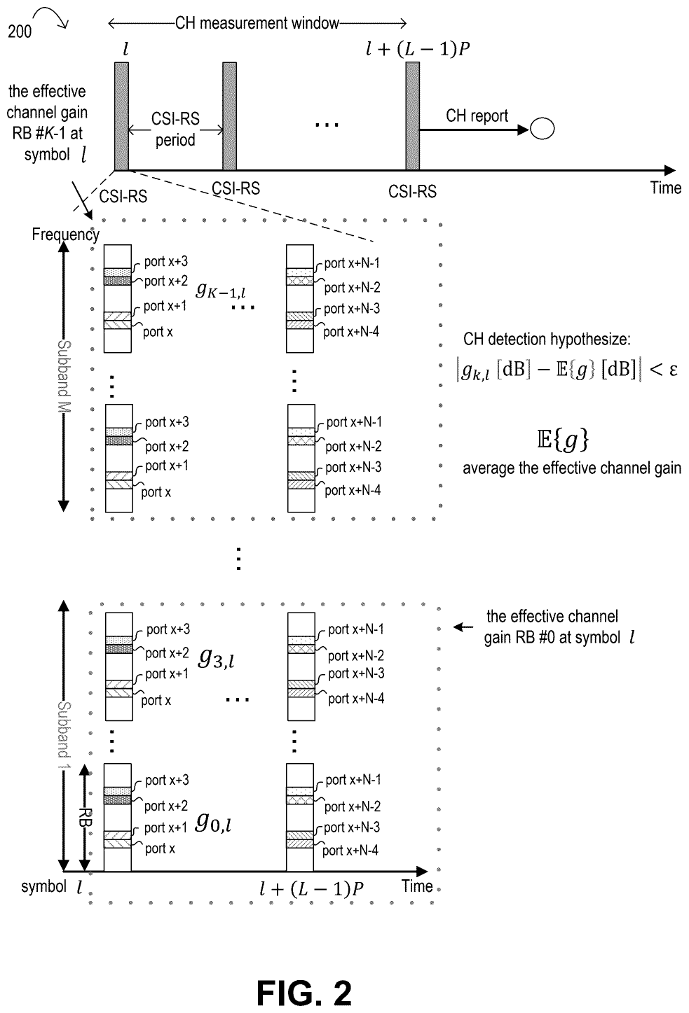

FIG. 2 illustrates a CH measurement in a measurement window and/or a measurement BW 200. In FIG. 2, a WTRU may calculate the effective channel gain each RB (e.g., it may be up to WTRU implementation). For example, a WTRU may average several RBs (e.g. 4 RBs) to obtain a better estimator of g_{k,l} g_{k,l+P} . . . g_{k,l+(L-1)*P} for each RS at OFDM symbol l, l+P, . . . l+(L−1)P and/or may calculate the average effective channel power gain with one or more (e.g., all) L RS.

Embodiments described herein may relate to CH reporting configuration. CH reporting configuration can be based on one or more of the following. CH reporting configuration may be based on periodic, aperiodic trigger-based (L2 MAC-CE, L3 RRC-based, L1-DCI-based trigger and/or associated resource, SL L2 MAC-CE, SL L3 RRC-based, SL L1-SCI-based trigger and/or associated SL resource), and/or wideband and/or subband reporting. For example, the WTRU may send the CH report aperiodically (e.g., based on one or more of layer 2 (L2)-medium access control (MAC) control entity (CE), radio resource control (RRC), or downlink control information (DCI)) and/or the CH report may be sent during a configured periodic and/or semi-persistent time window and/or domain.

CH reporting configuration may be based on periodic and/or semi-persistent RS resources. CH measurement reporting configuration can be based on periodic RS resources, and/or it may joint with other CSI reporting configuration such as L1-RSRP. Periodic CSI-RS resource(s), for example, 40 ms for L1-RSRP report and the CH report period (e.g., 160 ms, the CH measurement window) may be configured. CH report could be one or more (e.g., multiple) integers of CSI-RS period.

A WTRU may report CH feedback at each CH report period (e.g., the end of CH measurement window).

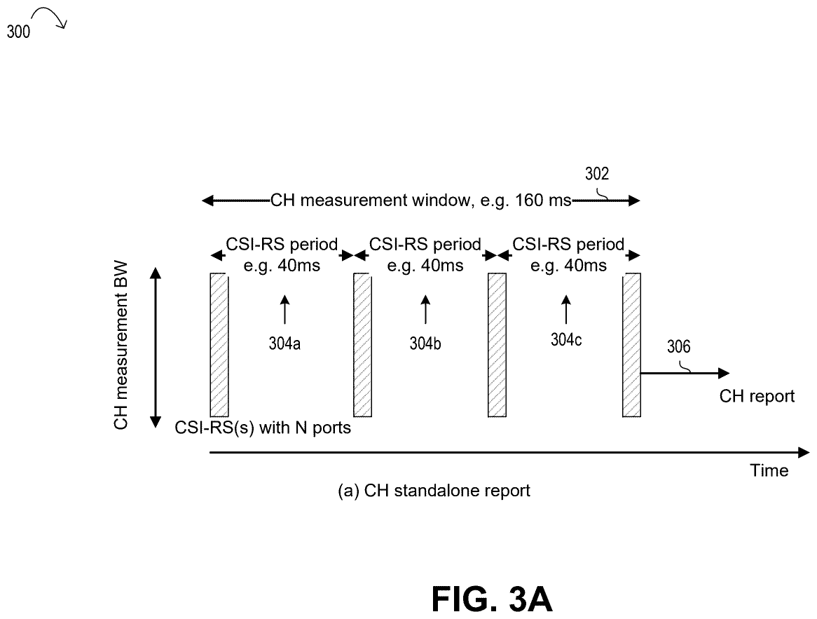

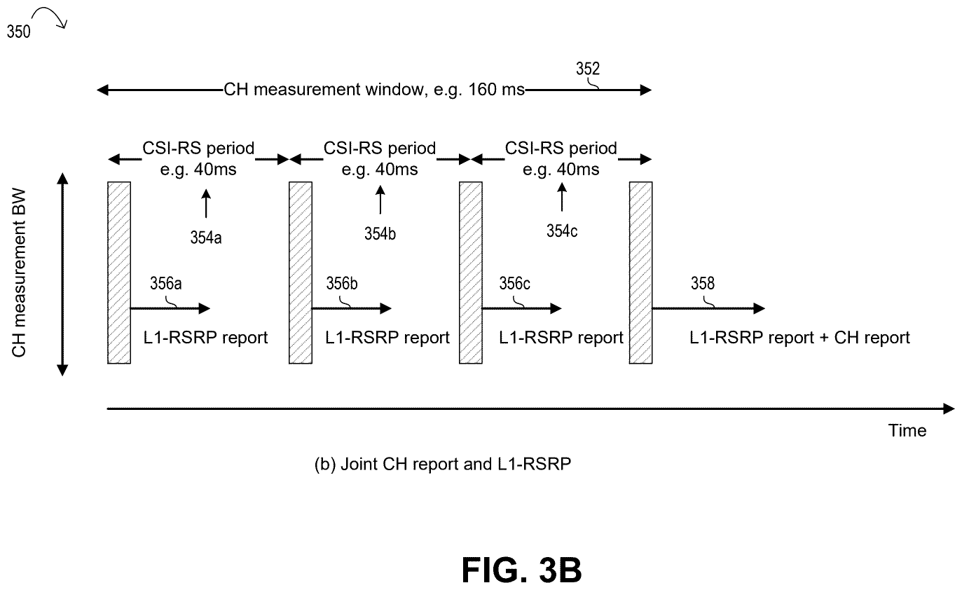

FIGS. 3A and 3B depict an exemplary periodic joint L1-RSRP and/or CH CSI report. As illustrated in FIGS. 3A and 3B, the WTRU may report L1-RSRP every 40 ms and report CH feedback every 160 ms. For every 160 ms, the WTRU joint may report L1-RSRP and CH feedback at the same time.

FIG. 3A depicts an example of CH standalone reporting 300. A CH measurement window may be 160 ms (e.g., 302). A CSI-RS period may be every 40 ms (e.g., 304a, 304b, 304c). At 306, the CH report may be sent at the end of the CH measurement window (e.g., at 160 ms).

FIG. 3B depicts an example joint CH report and L1-RSRP 350. A CH measurement window may be 160 ms (e.g., 352). A CSI-RS period may be 40 ms (e.g., 354a, 354b, 354c). A L1-RSRP report may be sent every 40 ms (e.g., at 356a, at 356b, at 356c, at 358). A L1-RSRP may be sent at the end of the CH measurement window (e.g., at 358), which may align with the end of a CSI-RS period (e.g., 354a, 354b, 354c). For example, a L1-RSRP report and CH report may be sent together and jointly at the same time (e.g., at 358).

Embodiments described herein may relate to aperiodic trigger-based (e.g., L2 MAC-CE, L3 RRC-based, L1-DCI-based trigger and/or associated resource). For example, the WTRU may send the CH report aperiodically (e.g., based on one or more of layer 2 (L2)-medium access control (MAC) control entity (CE), radio resource control (RRC), or downlink control information (DCI)) and/or the CH report may be sent during a configured periodic and/or semi-persistent time window and/or domain.

A WTRU may be configured association with aperiodic trigger-based approach using L2 MAC-CE based trigger. A L2 measurement and/or triggering mechanism may be associated with for CH reporting. The content may include measurement objects, triggering, and/or reporting criteria, etc. A WTRU may be configured by higher layer to monitor and/or detect CH occurrence. CH monitoring can be triggered by higher layer and/or higher layer can use L1-CH measurement for monitoring CH. CH reporting and/or triggering can be based on MAC layer and/or L2. A WTRU may monitor CH condition(s) to perform CH triggering and/or reporting procedure. CH triggering and/or reporting procedure can be a combined L1 and L2, where L1 may provide the L2/MAC layer indication(s) of CH feedback indication (CFI). CFI may have one or more different values (e.g., as described herein, as depicted in Table 1).

The L2 layer may count the CH indications and/or may declare altering CH occurrence when configured maximum number of CH Condition Indication (CCI) has been reached. For example, whenever the L1 detects the CH measurement n from RS goes larger than the “No CH” threshold ε₀, then it may send a “No CH” CH instance (CHI) to L2 indicating CH fails and L2 may increase a count for “No CH” accordingly.

No CH may be detected when the number of consecutive No CHI instances surpasses the configured (No CH) maximum count, with a time gap between each No CH instance not greater than a No CH Timer. MAC layer and/or L2 may start a timer when it receives No CCI and/or may increment the counter by 1 for every CHI. L1 may stop sending CHI to L2 and/or L1 may no longer detect CH feedback alternation. The WTRU MAC layer may have a timer running every time L1 reports a CCI (e.g., No CH CCI), for every occurrence, it increments CCI counter by 1 and/or may restart the timer. If there are not CH instances received at L2 and/or the timer expires, the L2 may reset the CHI counter and/or may determine that there are no more CHIs.

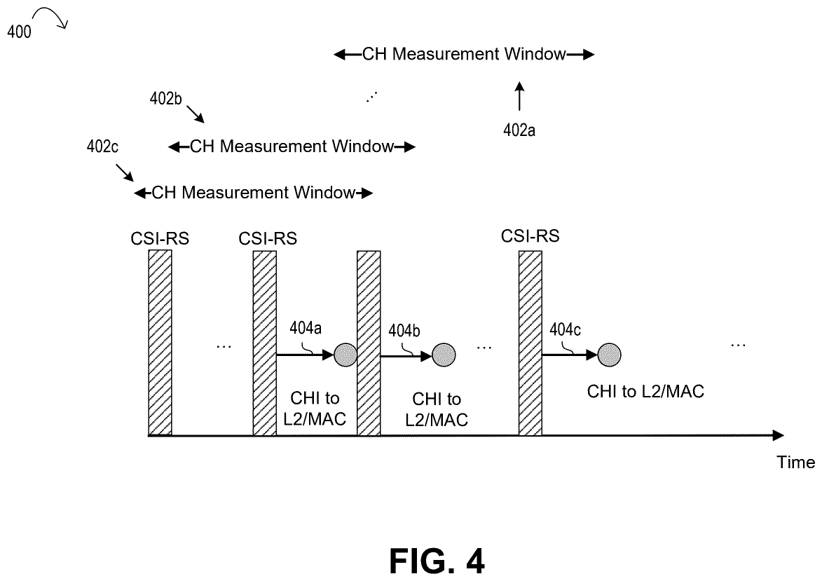

FIG. 4 depicts an exemplary illustration for WTRU to trigger alternation of CH occurrence based on periodic RS 400. For example, CHI may be reported to MAC layer and/or L2 from PHY layer and/or L1 at the end of each CH measurement window (e.g., 402a, 402b, 402c). CH measurement window may be implemented as a sliding window. A WTRU may calculate the CH measurement value [symbol] {g} to determine whether to send CHI (e.g. “No CH” and/or “CH”) to L2 (e.g., at 404a, at 404b, at 404c). Once L2 receives the CHI from L1, L2 may increment the counter by one (e.g. No CH, CH counter). Once the counter value reaches a maximum value, the WTRU may trigger a CH Condition Change Response (CCCR) report to the gNB. For example, the WTRU may send the CH report, where the CH report includes an indication that the CH condition has changed. The CH Occurrence Change (COC) can be similar to CSI CH report (e.g., as shown in Table 1). For example, when No CH counter is equal and/or greater than (No CH) the maximum counter, the WTRU may trigger No CH reporting (Table 1 index 0) and/or may send this triggering information back to gNB; the gNB may stop the WTRU for CH monitoring procedure. The WTRU may transmit then CH occurrence change (CH feedback) message on a physical random access channel (PRACH) (contention free or contention based), PUCCH, and/or PUSCH. The WTRU may report CCCR (e.g. X bits) via PRACH, PUCCH, and/or PUSCH; and/or the WTRU may report CCCR and/or CH with RSRP via physical random channel (PRACH), PUCCH, and/or PUSCH.

In the case of contention free random access (CFRA) for CH triggering and/or reporting, the gNB may (e.g., explicitly) provide the WTRU with resources for sending a random access (RA) request. The resources associated with that RS may be used for preamble transmission. If RA preamble indexes are not associated to RS(s), the preamble index of an SSB that is quasi-collocated (QCL-ed) with the selected RS may be used as the preamble index reported by the WTRU to the gNB.

The WTRU may send a CFRA request with resources the gNB allocated for CH triggering. The WTRU may monitor the control resource sets (CORESETs) for reception of PDSCH to receive a response to that request. If there is a CH notification about CH indication from L1, the L2 for CH triggering may be declared successfully completed.

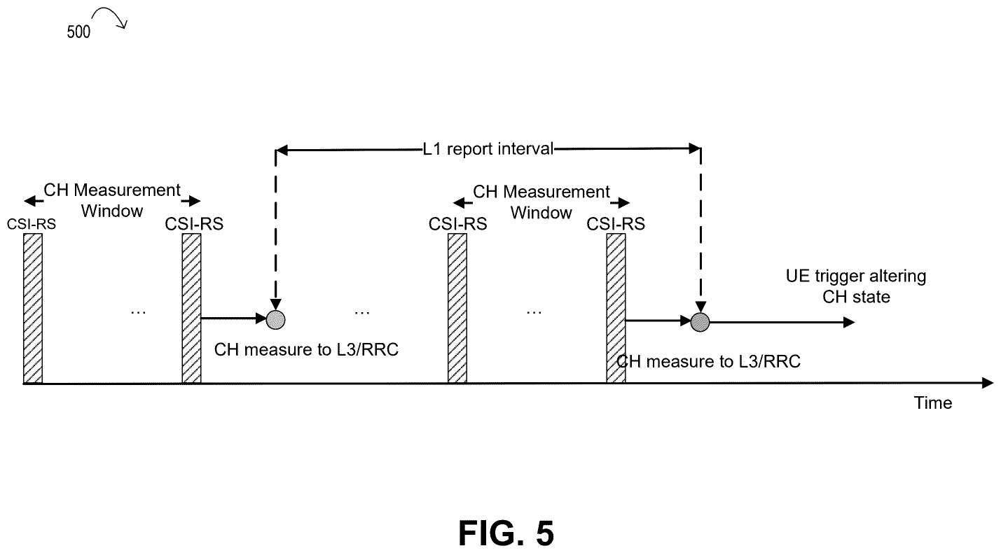

A WTRU may be configured in association with aperiodic trigger-based on L3 RRC-based trigger. Similar to other NR RRC measurement events (e.g., NR RRC event categories such as A1-A6 as intra RAT and/or B1-B2 as Inter RAT events), CH may be added into a RRC event because CH occurrence transition (e.g., from CH to no CH) may be slow in time because the CH effect may vary like mobility measurement events. CH event can be referred to as one of intra RRC events (e.g., RRC event AX and/or L3 filtering can remove the effect of short-term variations). Although L1 may collect CH measurements more often, L3 (RRC) might report them at a larger configured periodicity and/or RRC CH measurement may take a longer-term view of CH conditions; and/or may eliminate unnecessary WTRU CH triggering and/or reporting. A WTRU L3/RRC may collect CH measurement from L1, where the report interval can be configured. For example, the WTRU can be configured with a periodic CH-RS so the WTRU can report periodic L1 CH measure to L3 (e.g., as shown in FIG. 5).

FIG. 5 depicts an example of L1 CH measurements for RRC CH event 500.

Once WTRU L3/RRC layer receives L1 CH measure report(s), the WTRU may examine the CH measurement (e.g., for the serving cell) to determine whether the CH measurement exceeds the event threshold ε₀. For example, if the L1 CH measure quantity exceeds the event threshold ε₀+H_{y}, where H_{y} is the hysteresis parameter relating to this event, the WTRU can trigger event RRC CH event (e.g., No CH). For example, ε₀ can be defined as X [dB] (e.g. X=2) with H_{y}=1 [dB].

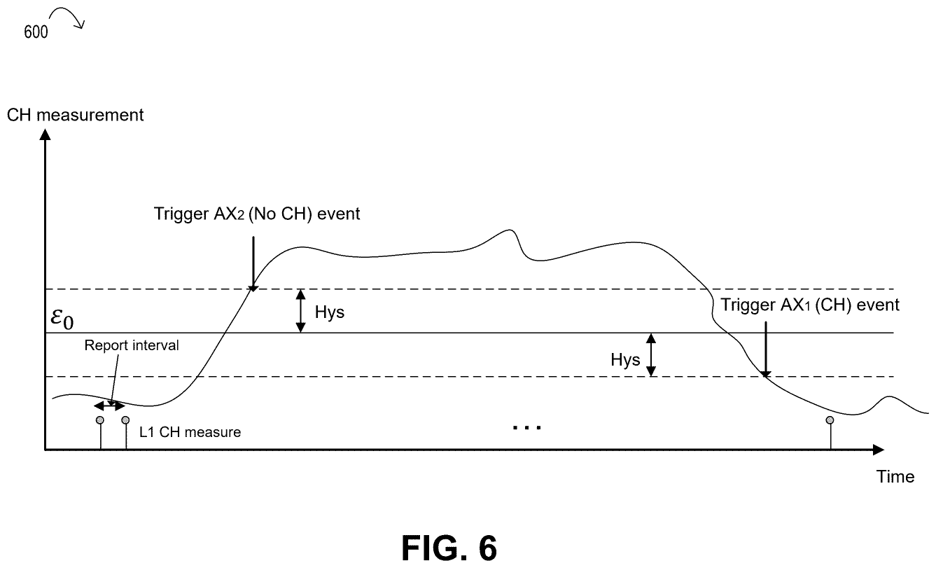

In contrast, if the L1 CH measure quantity is below the event threshold ε₀-H_{y}, the WTRU can trigger RRC event AX1 (e.g., CH is detected as shown in FIG. 6). CH events may be triggered based on the configurable thresholds and/or the hysteresis.

FIG. 6 depicts a CH event and/or triggering mechanism based on L3 600.

RRC event(s) for triggering CH may be described herein. A L3 measurement may be associated with CH occurrence change. The L3 measurement may include measurement objects, measurement ID, reporting criteria, measurement event definition, and/or the like. A WTRU may perform L3 measurement(s) (e.g., filtering of L1 measurements) according to the measurement configuration. The WTRU may report L3 measurement according to reporting configurations. A WTRU may be configured with event-triggering based reporting. For example, the RRC CH AX₂ event (e.g., no CH) may be triggered when the L3 CH measurement exceeds an event threshold ε₁ for the serving cell, and/or the CH AX₁ event may be triggered if below than a threshold ε₂ (e.g., CH occurrence).

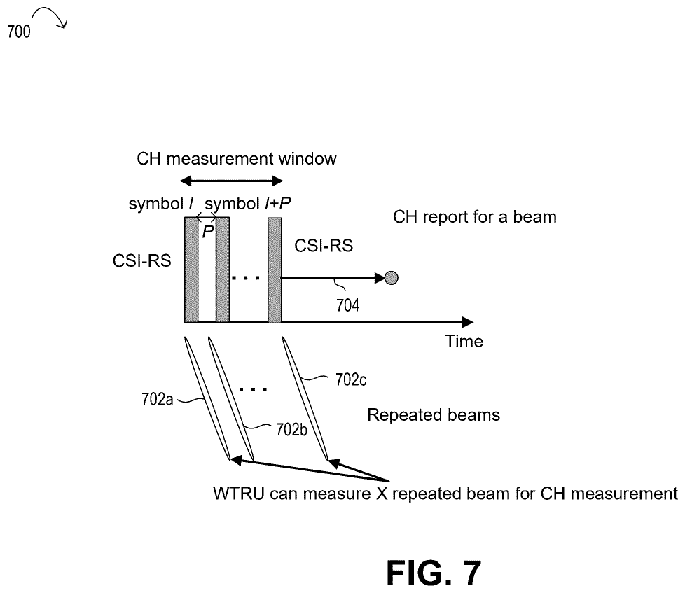

A WTRU may be configured in association with aperiodic trigger-based on L1-DCI-based trigger. CH measurement reporting may be based on layer one DCI based triggering. For example, DCI can trigger a WTRU to perform CH measurement and/or report based on aperiodic RS resources. For example, as shown in FIG. 7, a group of L aperiodic CSI-RS resources may be configured and/or transmitted for a WTRU to measure CH within a burst duration (measurement window). For example, L repeated beams (e.g., 702a, 702b, 702c) may be configured for a WTRU to measure CH. A first beam (e.g., 702a) may be the CSI-RS resource which is starting at the OFDM symbol I and/or the next repeated beam may be located at OFDM symbol l+P (e.g., 702b), where P is denoted as the CSI-RS resource (e.g., P=14) occurrence location (e.g., CSI-RS symbol location can be expressed as l, l+P, . . . (L−1)*P). After the last CSI-RS resource is received, a WTRU may report aperiodic CH feedback (e.g., at 704) after a scheduled time. To determine CH, the procedure may be similar to periodical RS resources. For example, the WTRU can examine the maximum deviation of the effective channel gain in each RB is within x dB relative with [symbol] {g} in a measurement BW during the CH measurement window, |g_{k,l} [d]− [symbol] {g} [dB]|<1 or k∈0 . . . K−1 and for l, l+P, . . . l+(L-1)P.

Each CH report may be based on the measurement BW (e.g., frequency domain granularity). One or more (e.g., two) possible CH reporting may be described herein. CH may be based on wideband report. For example, the CH measurement BW may be equal to a wide BW and/or the WTRU may report a wideband report (e.g., only). CH may be based on subband report. One or more (e.g., multiple) subbands may be configured for CSI CH reports; each subband may be associated with a CH report.

Embodiments described herein may relate to transmission format supported under CH conditions. The CSI reports (e.g., channel quality indicator (CQI) and/or L1-RSRP/L1-SINR reports can be reduced (e.g., transmitted less often with a longer periodicity) during CH due to the channel variation decreasing. The WTRU may be switched to a different CSI report period when CH is detected. Additionally or alternatively, other (e.g., new) DM-RS patterns for PDSCH transmission can be proposed when CH is detected. NR (e.g., existing NR) may (e.g., only) support limited DM-RS patterns (e.g., Type-I/II). While CH is detected, the effective channel may be flat across a certain BW and/or the demand for higher density pattern of DM-RS for channel estimation may be reduced. For example, lower density DM-RS pattern may be used and/or may be sufficient for channel estimation. The transmission formats for PDSCH configuration (e.g., reduced DM-RS patterns) can be used for the (e.g., implicit) indication of CH.

The number of DM-RS density can be reduced when channel is flat in a wide BW. The flat channel in a wide BW can imply the number of channel taps is near to a single path; it may reduce the RS overhead for channel estimation and/or CSI acquisition.

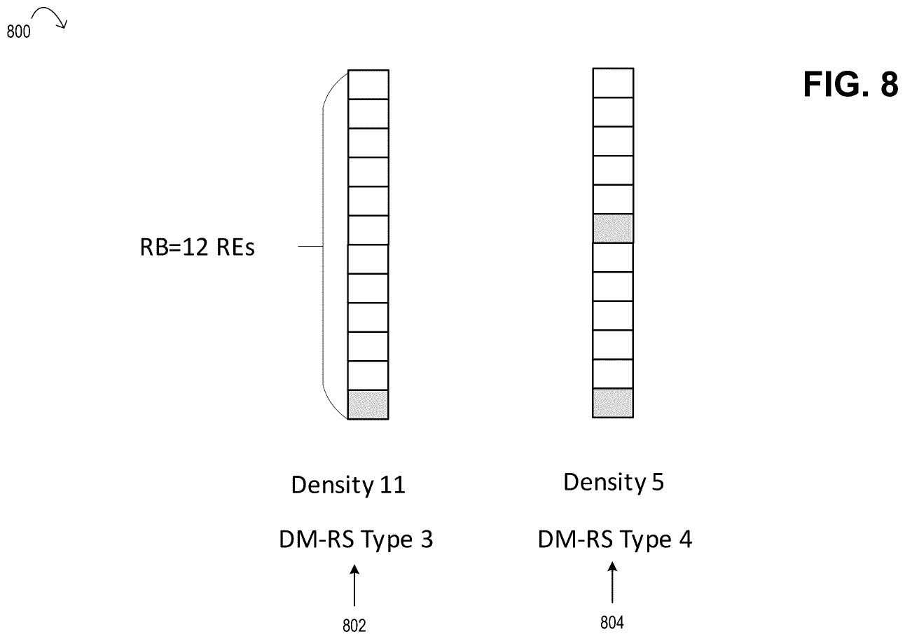

One of the examples of reporting channel hardening is that DM-RS frequency density can be reduced. To achieve this, other DM-RS configuration type(s) (e.g., 3, 4) for frequency domain density may be described herein. For instance, other less density DM-RS type(s) (e.g. type 3 802 and/or type 4 804) may be used when CH is detected (e.g., as shown in FIG. 8). A WTRU may report DM-RS pattern to gNB as PDSCH transmission format and/or the gNB can determine which PDSCH transmission is going to be used when CH is detected. In examples, the WTRU may receive different reconfiguration(s) for the reduced DMRS pattern. For example, other DM-RS patterns can be based on DMRS configuration and/or each DMRS configuration can be with different frequency density for PDSCH transmission. For example, when the WTRU is DM-RS configuration type 3 802, the WTRU may use the density Y (e.g. Y=11) pattern. For example, when the WTRU is DM-RS mapping type 4 804, the WTRU may use the density Y (e.g. Y=5) pattern (e.g., as shown in FIG. 8). A DM-RS mapping type can have different density pattern(s) and/or the association may be based on CH condition, state, and/or value . . . . For example, the CH condition may include a positive CH condition and/or a negative CH condition. The transmission configuration may include a first transmission format (e.g., DMRS type 3, DMRS type 4) and/or a second transmission format (e.g., DMRS type 1, DMRS type 2). The reception configuration may include a first reception format (e.g., DMRS type 3, DMRS type 4) and/or a second reception format (e.g., DMRS type 1, DMRS type 2). The WTRU may apply the first transmission formal and/or the first reception format based at least on the positive CH condition. The WTRU may apply the second transmission and/or second reception format based at least on the negative CH condition. The WTRU may reduce DM-RS density, associated with time and/or frequency, based on a determination that the CH condition includes the positive CH condition. The positive CH condition may include the effective delay spread and/or the effective channel gain, in a time domain and/or a frequency domain, below a threshold (e.g., included in the CH measurement configuration information). The negative CH condition may include the effective channel gain and/or the effective delay spread, in a time and/or a frequency domain, equal to and/or greater than a threshold (e.g., included in the CH measurement configuration information).

A WTRU may report the supported DM-RS patterns as an indication of CH to gNB. Upon receiving channel hardening feedback from the WTRU (e.g., via L1 report and/or WTRU triggering), for example, the gNB may configure DL DM-RS density and/or pattern for the WTRU PDSCH reception and/or the WTRU may receive re-configuration of the DL DM-RS mapping type indicated in DCI. When the WTRU receives other (e.g., new) DL and/or UL DM-RS type, the WTRU may determine the implicit indication of channel hardening.

In examples, the WTRU may be fallback to (e.g., legacy)PDSCH transmission, which may mean no DM-RS reduction. In examples, the WTRU may transmit the initial transmission of the PDSCH with reduced DMRS and/or without DMRS. When negative acknowledgement (NACK) is generated for a received PDSCH, the WTRU may start to trigger a counter and/or a timer. For example, when the WTRU receives KNACK consecutive NACK and KNACK>KT, where Kr is the value of the threshold configured by the gNB for the WTRU to trigger the fallback, the WTRU may feedback the fallback with DM-RS pattern configured for the (e.g., legacy)PUSCH transmission.

A WTRU may be configured to report CH in association with one or more different formats. CH report can be similar to CQI type of reporting (e.g., support for periodic and/or aperiodic reporting). A WTRU may report the CH feedback via PUCCH and/or PUSCH. The CH feedback format can be based on the reporting configuration. For example, the CH feedback format can be (e.g., either) short and/or long format. If short CH feedback, the WTRU may report status as the exemplary CH feedback listing in Table 1. Like Table 1, the WTRU can report the detection status of CH; the required number of feedback bits can be short and/or it may be feasible to use short PUCCH format for CH feedback. Short and/or long PUCCH format may be used to transmit CH feedback. For example, either short or long PUCCH format may be used to transmit CH feedback. In examples, when CH feedback is schedule to transmit using short PUCCH format. Due to limited bits in the short PUCCH format, for example, in case of scheduled higher priority hybrid automatic repeat request (HARQ) acknowledgement (ACK)/NACK and/or scheduling request (SR) bit (e.g., format 0/1) may be transmitted together and/or jointly with CH feedback. A dropping rule may be introduced and/or defined to multiplex the feedback or one or more other signals (e.g., for HARQ ACK/NACK, SR, and/or CH). For example, feedback (e.g., some feedback) may be dropped based on the priority which may be (pre) configured and/or (pre) defined. In case CH feedback has lower priority (e.g., configured and/or predefined to be lower priority) than HARQ ACK/NACK, then CH feedback transmission may be dropped due to its lower priority than HARQ ACK/NACK and/or SR if they occur at the same time. Additionally or alternatively, lower priority feedback may use another format and/or channel to transmit if they are not dropped.

TABLE 1
An exemplary CH feedback based on the deviation
of the effective channel gain.

| index | Bits | Remark |
|---|---|---|
| 0 | 00 | No CH |
| 1 | 01 | CH and the maximum deviation of the effective channel |
| | | gain in each PRB or PRB group (e.g. PRBs) is within |
| | | a threshold X (e.g. X = 0.5) dB in a measurement BW. |
| 2 | 10 | CH and the maximum deviation of the effective channel |
| | | gain in each RB or PRB group is within a threshold Y |
| | | dB (e.g. Y = 1) in a measurement BW. |
| 3 | 11 | reserved |

Other alternative CH feedback format may be based on the small-fading parameter such as the coherence BW exceeds a threshold and/or equivalent value, and/or the delay spread is below than a threshold. This may be because when the coherence BW is large, which equivalently indicates the delay spread is short (e.g., the effective channel is flat when BF and/or precoding case). CH feedback format may be based on the delay spread, for example, when the max delay spready is shorter than a threshold (e.g., Z ns). When this condition is true, the WTRU can feedback a single bit and/or two bits feedback (e.g., as shown in Table 2) to indicate that CH is detected. Table 2 depicts an exemplary for CH feedback based on the length of delay spread as the CH measurement metric.

TABLE 2
An exemplary of CH feedback based on
the effective channel delay spread

| index | Bits | Remark |
|---|---|---|
| 0 | 00 | No CH |
| 1 | 01 | The delay spread is less than a threshold, e.g., Z₁ ns in a |
| | | measurement window. |
| 2 | 10 | The delay spread is less than a threshold, e.g., Z₂ ns but |
| | | great than a threshold, e.g., Z₁ ns in a measurement |
| | | window. |
| 3 | 11 | reserved |

The CH metric (e.g., channel gain, delay spread) can combine with DMRS pattern as an indication of CH to gNB. For example, as shown in Table 3, CH metric (e.g., delay spread and/or channel gain) jointly together with DM-RS pattern may be used for CH feedback format. In examples, the feedback format may take larger size than CH metric feedback (e.g., only CH metric, not including DM-RS pattern in the same feedback format). The long PUCCH and/or PUSCH may be used to transmit this kind of CH feedback format of larger size (e.g., CH metric and/or DM-RS pattern).

Additionally or alternatively, feedback of CH feedback format may be that CH metric (e.g., delay spread and/or channel gain) can be combined/joint with other CSI report (e.g., L1-RSRP, L1-SINR). For example, CH feedback may be multiplexing with other CSI report such as L1-RSRP/L1-SINR. In examples, long format PUCCH and/or PUSCH can (e.g., also) be used for carrying CSI report.

TABLE 3
An exemplary CH feedback delay spread with DM-RS pattern

| Type | Remark |
|---|---|
| 0 | No CH |
| 1 | The delay spread is less than a threshold, e.g., Z₁ ns in a |
| | measurement window and DM-RS pattern X1. |
| 2 | The delay spread is less than a threshold, e.g., Z₂ ns but great than |
| | a threshold, e.g., Z₁ ns in a measurement window and DM-RS |
| | pattern X2. |
| 3 | reserved |

If CH report format is triggered-based like MAC-CE and/or L3/RRC based, and/or if the WTRU has allocated contention free PRACH resources, the WTRU may trigger the CH report via PRACH (e.g., contention free), PUCCH, and/or PUSCH.

According to reporting mechanism configuration, the WTRU may perform L3 measurement (e.g., filtering of L1 measurements) and/or may report the channel hardening feedback using a L3 mechanism. In examples, the WTRU may receive an event-triggering based channel hardening reporting configuration. For example, the RRC CH AX₂ reporting event (e.g., reporting of no CH) may be triggered when the L3 CH measurement exceeds an event threshold ε₁ for the serving cell, and/or the CH AX₁ event may be triggered if below than a threshold ε₂ (e.g., reporting of CH occurrence). An exemplary RRC configuration for CH event triggered reporting is shown below in Table 4.

TABLE 4
CH triggering event via L3/RRC
EventTriggerConfigInterRAT

| | |
|---|---|
| eventId | |
| event | Events AX |
| No CH-Threshold | A threshold for indication no CH |
| Hard CH-Threshold | A threshold for indication for CH |
| Hysteresis (Hy) | INTEGER (0 . . . 30) |
| timeToTrigger | 0, 40, 64, 80, . . . 5120 msec |
| rsType | ENUMERATED {csi-rs} |
| reportInterval | 120 msec, 240 msec, . . . 12 min, 30 min |
| reportAmount | ENUMERATED {r1, r2, r4, r8, r16, r32, r64, |
| | infinity} |
| reportQuantity | CH measurement quantity |

PDCCH monitoring can be enhanced to take the advantage of channel hardening. Design of PDCCH can consider configuring search space (SS) and/or SS set groups (SSSG) to match WTRU's more deterministic channel condition(s). The WTRU's deterministic channel condition(s) can be linked to a particular PDCCH aggregation level (AL) for a DCI size and/or a reduced Als, for example, instead of one or more (e.g., all) possible Als (1, 2, 4, 8, 16). If a WTRU's SS configuration includes (e.g., only) one and/or limited ALs, for example, the PDCCH monitoring complexity (e.g., blind detection (BD) effort) and/or power consumption at the WTRU may be reduced. For PDCCH, based on the WTRU channel hardening feedback, the WTRU may be notified with a (e.g., WTRU-specific) SS(s) and/or SSSG where the number of PDCCH candidates and/or ALs may be reduced. A WTRU may apply a first set of one or more search spaces based on a positive CH condition and/or apply a second set of one or more search spaces based on a negative CH condition.

The WTRU may indicate a preferred SSSG (and/or its associated ALs) that the block error rate (BLER) of hypothetical PDCCH can meet the Qin threshold of 2% in its CH-radio link failure (RLF) report to the gNB.

The WTRU may monitor the DL quality based on the reference signal (e.g., RS can be PDCCH DM-RS and/or a CSI-RS) and/or may calculate the BLER fo hypothetical PDCCH transmission of associated aggregation of its current SSSG. If the BLER of hypothetical PDCCH transmission exceeds a threshold (e.g., Qout threshold 10%), the WTRU may report the CH-RLF to the gNB and/or may fall back to its default SSG (e.g., no CH).

For time division duplex (TDD), for example, the WTRU can determine CH occurrence can be applicable for (e.g., both) DL and/or UL. The gNB may signal a WTRU to switch to CSI report without CH, for example, CH measurement may be disabled. The gNB can send the signaling to the WTRU to stop CH measurement and/or report.

In NR, for example, semi-persistent CSI report can be enabled and/or disabled for certain CSI report configuration(s) when CH is detected. For example, the gNB may disable the existing CSI report configuration and enable another CSI report configuration to reduce the CSI report overhead. For example, the WTRU may be switch to a different CSI report configuration for wideband CQI reporting to reduce the CQI overhead because each subband CQI has similar CQI value and/or no subband CQI may be required when CH is detected. For example, semi-persistent CSI report can be enabled and/or disabled for certain CSI report configuration when CH is detected. The gNB may disable the existing CSI report configuration and/or enable another CSI report configuration to reduce the CSI report overhead. For example, the WTRU may switch to a different CSI report configuration for wideband CQI reporting to reduce the CQI overhead because each subband CQI has similar CQI value and/or no subband CQI may be required when CH is detected.

Methods and solutions described herein can be applied to different and/or one or more (e.g., variety of) channels such as DL channels, UL channels, sidelink channels, and/or the like. Transmit node and/or Tx node may be a gNB, transmission/reception point (TRP), transmit WTRU and/or Tx WTRU, Tx vehicle WTRU (VWTRU), and/or the like. Receive node or Rx node may be a gNB, TRP, receive WTRU or Rx WTRU, Rx VWTRU, and/or the like.

Embodiments described herein may relate to a WTRU that is configured to perform one or more actions. A WTRU may detect that the measured CH condition(s) that meet a certain criterion (e.g., configured threshold(s)). The WTRU may determine the measured CH condition(s) according to the CH measurement and/or the reporting configuration. The WTRU may report and/or apply a transmission configuration associated with a CH condition or a set of CH conditions based on the detecting CH conditions on the DL, UL, and/or SL using a configured CH measurement and/or reporting configuration. The WTRU may indicate the supported reception and/or transmission configuration(s) to the network, and/or (e.g., autonomously) activate the supported reception and/or transmission configuration(s) to a subsequent reception and/or transmission and/or a series of subsequent receptions and/or transmissions. For example, the CH condition may include a positive CH condition and/or a negative CH condition. The transmission configuration may include a first transmission format (e.g., DMRS type 3, DMRS type 4) and/or a second transmission format (e.g., DMRS type 1, DMRS type 2). The reception configuration may include a first reception format (e.g., DMRS type 3, DMRS type 4) and/or a second reception format (e.g., DMRS type 1, DMRS type 2). The WTRU may apply the first transmission formal and/or the first reception format based at least on the positive CH condition. The WTRU may apply the second transmission and/or second reception format based at least on the negative CH condition. The WTRU may reduce DM-RS density, associated with time and/or frequency, based on a determination that the CH condition includes the positive CH condition. The positive CH condition may include the effective delay spread and/or the effective channel gain, in a time domain and/or a frequency domain, below a threshold (e.g., included in the CH measurement configuration information). The negative CH condition may include the effective channel gain and/or the effective delay spread, in a time and/or a frequency domain, equal to and/or greater than a threshold (e.g., included in the CH measurement configuration information).

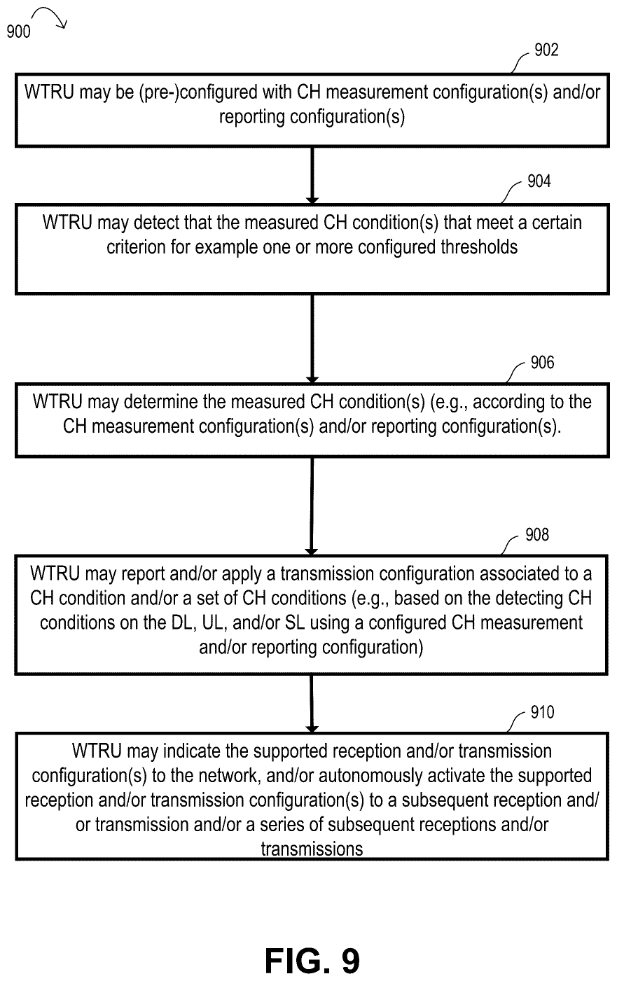

FIG. 9 depicts methods and/or procedures for CH 900. The WTRU methods and/or procedures may be applied to DL/UL, and/or Sidelink. At 902, a WTRU may be (pre) configured with CH measurement configuration(s) and/or reporting configurations. At 904, the WTRU may detect that the measured CH condition(s) that meet a certain criterion (e.g., one or more configured thresholds). At 906, the WTRU may determine the measured CH conditions according to the CH measurement configuration(s) and/or reporting configuration(s). At 908, the WTRU may report and/or apply a transmission configuration associated to a CH condition and/or a set of CH conditions, for example, based on the detecting CH conditions on the DL, UL, and/or SL using a configured CH measurement and/or reporting configuration. At 910, the WTRU may indicate the supported reception and/or transmission configuration(s) to the network, and/or (e.g., autonomously) activate the supported reception and/or transmission configuration(s) to a subsequent reception and/or transmission and/or a series of subsequent receptions and/or transmissions.

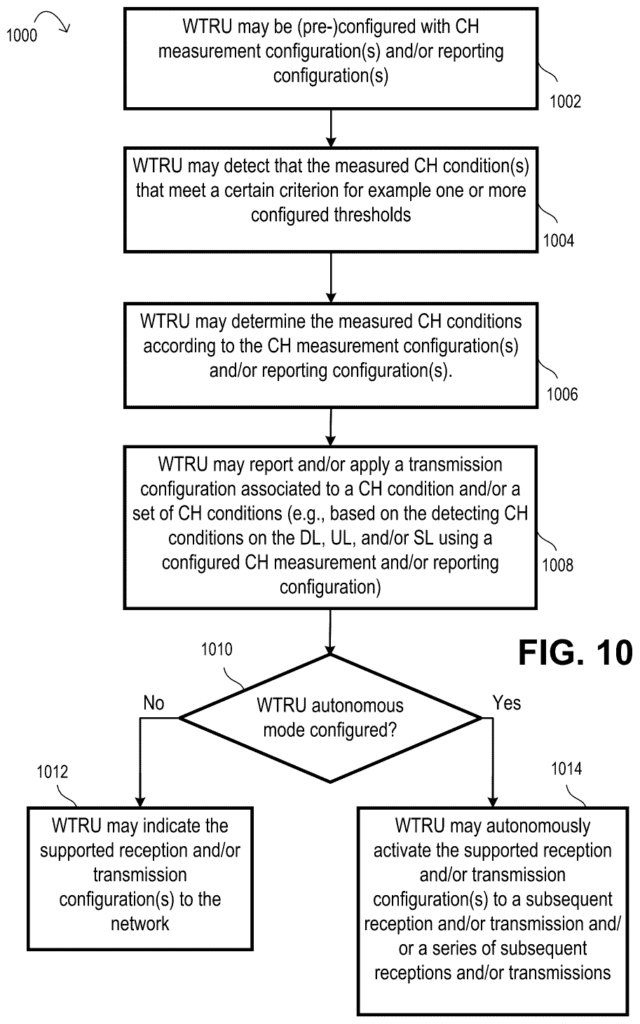

FIG. 10 depicts an exemplary flow chart for methods and/or procedures for WTRU autonomous CH mode 1000. A WTRU may receive configuration indicator to determine which operation mode for transmission/reception configuration. For example, WTRU may receive configuration indicator (e.g., mode A) to indicate the supported reception and/or transmission configuration(s) to the network. The WTRU may receive configuration indicator (e.g., mode B) to autonomously activate the supported reception and/or transmission configuration(s) to a subsequent reception and/or transmission and/or a series of subsequent receptions and/or transmissions.

At 1002, a WTRU may be (pre) configured with CH measurement configuration(s) and/or reporting configurations. At 1004, the WTRU may detect that the measured CH condition(s) that meet a certain criterion (e.g., one or more configured thresholds). At 1006, the WTRU may determine the measured CH conditions according to the CH measurement configuration(s) and/or reporting configuration(s). At 1008, the WTRU may report and/or apply a transmission configuration associated to a CH condition and/or a set of CH conditions, for example, based on the detecting CH conditions on the DL, UL, and/or SL using a configured CH measurement and/or reporting configuration. At 1010, the WTRU may determine whether a WTRU autonomous mode (e.g., as described herein, mode A, mode B, etc.) is configured. If an autonomous mode is configured (e.g., at 1014), the WTRU may autonomously activate the supported reception and/or transmission configuration(s) to a subsequent reception and/or transmission and/or a series of subsequent receptions and/or transmission. For example, on a condition that the WTRU is configured with an autonomous mode, the WTRU may autonomously activate one or more of a reception and/or transmission configuration(s) included in the set of reception and/or transmission configuration information, for one or more subsequent receptions and/or transmissions. If a WTRU autonomous mode is not configured (e.g., at 1012), the WTRU may indicate the supported reception and/or transmission configuration(s) to the network. For example, on a condition that the WTRU is not configured with an autonomous mode, the WTRU may send an indication of supported one or more reception and/or transmission configurations to a network node.

A WTRU may perform one or more actions for DL and/or UL. The WTRU may perform one or more of the following actions for DL when CH. The WTRU may perform the reception of PDSCH using the DM-RS pattern (e.g., corresponding to channel hardening condition) as explicitly and/or implicitly signaled for CH. The WTRU may perform PDCCH detection according to the DL search space re-configuration received from the gNB. The restricted aggregation level may correspond to channel hardening condition. For example, a WTRU may apply a first set of one or more search spaces based on a positive CH condition and/or apply a second set of one or more search spaces based on a negative CH condition.

For DL-related WTRU actions, the WTRU may receive DL with different formats (e.g., with different DMRS patterns and/or densities, PDCCH with different ALs, and/or SS with different DCI formats); different PDSCH formats may be indicated in the DCI. When channel is hardening, the gNB may reconfigure the DM-RS configuration and/or the WTRU may determine the PDSCH DM-RS being mapped to physical resources according to configuration type (e.g., 3, 4) as given by the higher-layer parameter DM-RS type in DMRS-Downlink Configuration for a PDSCH configuration.

A WTRU procedure for PDCCH SS switching during CH may be described herein. A WTRU may be configured with one or more (e.g., multiple) SSSG for indication of CH. For example, the WTRU can be configured with at least two SSSG (e.g., one SSSG may be used when the WTRU is no CH (default SSSG), and/or the other SSSG may be used when the WTRU is in channel hardening).

A WTRU may be signaled with SS space set switching from network (NW) and/or transmit node. Additionally or alternatively, the WTRU may (e.g., autonomously) signal a SS space set switching indication to NW and/or transmit node. The WTRU may switch to its in-(CH) SS/SSSG with limited ALs. The activation and/or switching of SS/SSSG can be done as the part of handshaking signaling of channel hardening report between gNB and WTRU via DCI and/or MAC-CE. For example, the WTRU may switch to a SS group with AL {2, 4} and/or a SS group with ALs {2, 4, 8}.

One out of every N PDCCH monitoring occasions and/or based on a timer, a WTRU may switch back to the default SSSG (no-CH SSSG) to perform PDCCH monitoring.

A WTRU may perform CH monitoring and/or the WTRU may fall back to the default SSSG (no CH) when CH condition changes. Additionally or alternatively, the gNB can indicate to the WTRU to monitor the default SS and/or stop monitoring other CH SSSG (e.g., at any time).

A WTRU procedure for aperiodic trigger-based (e.g., L2-MAC-CE) may be described herein. A WTRU may perform (L1) CH measurement based on configured RS(s) (e.g., CSI-RS resources). CH measurement configuration may be similar to L1-based CH measurement. For example, the WTRU may be configured with (e.g., periodic) RS resources for monitoring L1-based CH measurement. A WTRU may determine whether CH (e.g., CH condition) is detected. The determination of the CH condition may be based on a CH metric. The CH metric may include an effective delay spread and/or an effective channel gain. The CH condition may be based on a deviation of the effective channel gain in accordance with the CH measurement configuration information. The CH condition may be based on a determination that the effective delay spread is less than a threshold (e.g., included in the CH measurement configuration information). If the WTRU detects CH may (e.g., need to) be adjusted, the WTRU may trigger a reporting. The CH feedback change detection (e.g., from CH to no CH) at the WTRU may be a L1/L2 combined procedure, where L1 performs the physical (PHY) layer measurement and L2 decides the triggering of CH condition change(s). For example, when PHY layer/L1 detects a L1 CH measurement above a pre-defined threshold ε₀, the PHY layer may trigger a CH feedback indication (CFI) and/or may send it to the L2 (MAC). For example, the MAC layer may start a timer as soon as it receives CFI, and/or it may keep incrementing the counter by 1 for every CFI instance. When the counter of CFI exceeds the maximum value before the timer expires, for example, the MAC may trigger CH feedback change (CFC) and/or may start the change procedure. A WTRU may transmit the CH change message on PRACH, PUSCH, and/or PUCCH. For example, the WTRU may send the CH report, where the CH report includes an indication that the CH condition has changed. The WTRU may report CH feedback (e.g., X bits) via PRACH, PUCCH, and/or PUSCH; and/or the WTRU may report CH feedback with RSRP via PRACH, PUCCH, and/or PUSCH. A WTRU may receive a CH feedback change response (CFCR) message from the gNB (e.g., as an acknowledgement). The WTRU may be indicated to stop monitoring L2-based CH triggering report by the gNB. If the WTRU is configured with periodic CH report, for example, the WTRU may stop to monitor periodic RS for CH detection.

A WTRU may perform one or more actions for UL when CH is detected (e.g., for TDD case where channel reciprocity is assumed). The WTRU may perform transmission of PUSCH and/or PUCCH using the DM-RS pattern (e.g., corresponding to channel hardening condition) as explicitly and/or implicitly signaled for CH. In examples, the WTRU may reduce the DMRS transmission in PUSCH/PUCCH. For example, a different DMRS (e.g., DMRS with a different DMRS pattern and/or with less density in time and/or frequency domain) may be signaled for CH. In examples, the WTRU may remove the DMRS transmission in PUSCH/PUCCH (e.g., transmit PUSCH/PUCCH without DMRS when CH. Additionally or alternatively, a different PUCCH/PUSCH format may be introduced for CH, where the DMRS associated with the other (e.g., new)PUCCH/PUSCH format may be different from the DMRS for (e.g., legacy) PUCCH/PUSCH format. For example, the CH condition may include a positive CH condition and/or a negative CH condition. The transmission configuration may include a first transmission format (e.g., DMRS type 3, DMRS type 4) and/or a second transmission format (e.g., DMRS type 1, DMRS type 2). The reception configuration may include a first reception format (e.g., DMRS type 3, DMRS type 4) and/or a second reception format (e.g., DMRS type 1, DMRS type 2). The WTRU may apply the first transmission formal and/or the first reception format based at least on the positive CH condition. The WTRU may apply the second transmission and/or second reception format based at least on the negative CH condition. The WTRU may reduce DM-RS density, associated with time and/or frequency, based on a determination that the CH condition includes the positive CH condition. The positive CH condition may include the effective delay spread and/or the effective channel gain, in a time domain and/or a frequency domain, below a threshold (e.g., included in the CH measurement configuration information). The negative CH condition may include the effective channel gain and/or the effective delay spread, in a time and/or a frequency domain, equal to and/or greater than a threshold (e.g., included in the CH measurement configuration information).

The WTRU may perform transmission of SRS using a different SRS configuration signaled for CH. In examples, UL DMRS and/or other RS may be used for CH measurement and/or detection. The WTRU may no longer transmit the SRS in the UL when it is under CH. In examples, SRS may be used for CH measurement and/or detection. The WTRU may be explicitly and/or implicitly signaled with a different SRS configuration. The WTRU may transmit the SRS as signaled by the gNB when it is under CH.

The WTRU may perform transmission of CSI reporting using a different CSI reporting configuration signaled for CH. The signaled CSI reporting configuration may have a different periodicity for the WTRU to report the CSI. Another (e.g., new) metric (e.g., CH reporting) may be reported using the signaled CSI reporting configuration when the WTRU is under CH.

In examples, the WTRU may fall back to (e.g., legacy)PUCCH/PUSCH transmission. In examples, the WTRU may transmit the initial transmission of the PUSCH with reduced DMRS and/or without DMRS. When NACK is received for the transmitted PUSCH, the WTRU may retransmit the PUSCH with another DM-RS pattern (e.g., with higher density) to improve the reliability. Additionally or alternatively, the WTRU may retransmit the PUSCH with DM-RS pattern configured for the (e.g., legacy)PUSCH transmission. In examples, the fallback may be trigger by a counter and/or a timer. For example, when a WTRU is transmitting the PUSCH with the DMRS pattern configured for CH, if the WTRU receives K_{NACK} consecutive NACK and K_{NACK}>K_{T}, where K_{T} is the value of the threshold configured by the gNB for the WTRU to trigger the fallback, the WTRU may transmit the subsequent PUSCH(s) with DM-RS pattern configured for the (e.g., legacy)PUSCH transmission.

Channel hardening may occur in SL. When CH occurs in SL, the SL channel may behave as almost fully deterministic as the number of antennas increases. When the number of WTRUs transmit PSSCH simultaneously, the number of antennas may increase, which may result in CH in SL; the effective channel of SL may become hardened and/or can be modeled as a single tap (e.g., frequency flat). The channel hardening condition in SL may last for a certain period of time. In SL massively distributed MIMO (MD-MIMO) system, when the number of antennas is (e.g., very) large, the effective channel fluctuations may decrease and/or the effective channel gain may be getting hard. As the channel becomes more hard, channel gain of the wireless channel may include less fluctuation and/or variation.

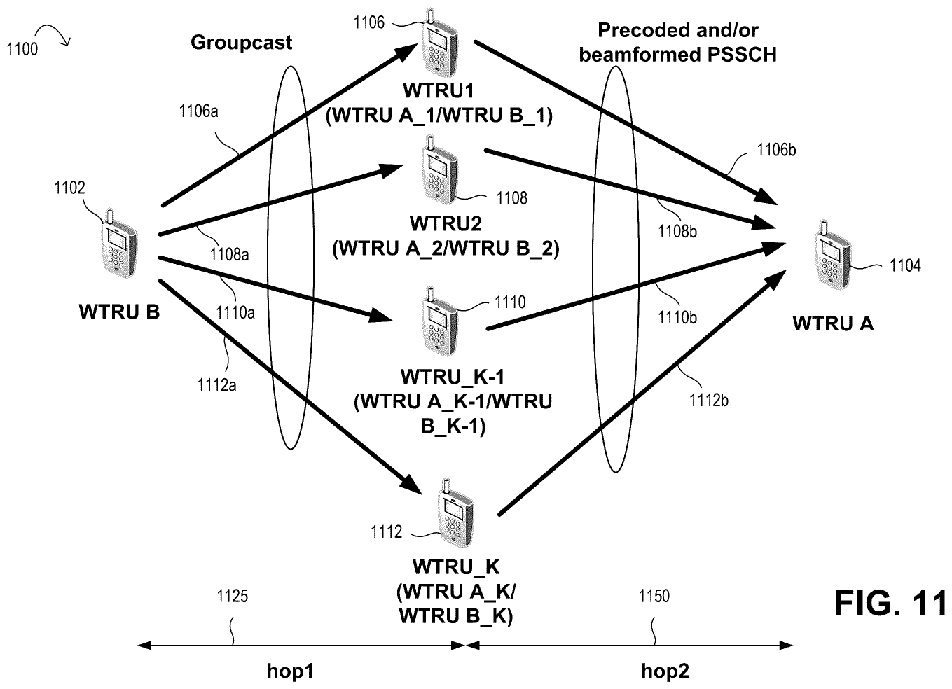

FIG. 11 depicts an example distributed MIMO-SL operations 1100. In a SL mesh network, Tx WTRU may transmit (e.g., at 1106a, at 1108a, at 1110a, at 1112a) a PSSCH to a group of intermediate Rx WTRUs. The transmit WTRU may be WTRU B 1102 and/or the receive WTRU may be WTRU A 1104. This may be done via groupcast (e.g., in a first hop 1125). In another hop (e.g., 1150), Rx WTRUs (e.g., 1106, 1108, 1110, 1112) may become TX WTRU and/or may transmit and/or relay the PSSCH to a destination WTRU (e.g., 1104). The transmit WTRU may be WTRU B and/or the receive WTRU may be WTRU A. This may be done via precoded and/or beamformed IPSSCH. For example, WTRU1 1106 may receive the groupcast (e.g., at 1106a) and transmit (e.g., at 1106b) the precoded and/or beamformed PSSCH to the WTRU A 1104. WTRU2 1106 may receive the groupcast (e.g., at 1108a) and/or may transmit (e.g., at 1108b) the precoded and/or beamformed PSSCH to the WTRU A 1104. WTRUK 1112 may receive the groupcast (e.g., at 1112a) and/or may transmit (e.g., at 1112b) the precoded and/or beamformed PSSCH to the WTRU A 1104. Since the aggregated antennas (e.g., for WTRU1 1106, WTRU2 1108, . . . , WTRU K 1112) are large, CH may occur. For example, WTRU1 1106, WTRU2 1108, . . . , WTRU K 1112 may receive the groupcast and/or may transmit the precoded and/or beamformed PSSCH simultaneously (e.g., via joint transmission) to the WTRU A 1104. For example, transmission may be coherent joint transmission.

A group of WTRUs (e.g., may be (pre) configured for receiving groupcast PSSCH. This group of RX WTRU may be intermediate Rx WTRUs for a hop in mesh communication. The WTRU set may be set S1. For example, Set S1 1104 may include WTRU1 (WTRU A_1/WTRU B_1) 1106 to WTRU_K (WTRU A_K/WTRU B_K 1112 and group size of Set S1 may be K (i.e., K WTRUs in Set S1). For example, set S1 may include WTRU1 1106 (e.g., WTRU A_1/WTRU B_1) to WTRU_K 1112 (e.g., WTRU A_K/WTRU B_K) and/or group size of set S1 may be K (e.g., K WTRUs in set 1).

A group of WTRUs may be (pre) configured for transmitting PSSCH simultaneously based on the received groupcast PSSCH. The WTRU may be set S2. The WTRU set S2 may be equal to or smaller than WTRU set S1.

The WTRU may transmit PSSCH to WTRU set S1 via groupcast. The Rx WTRU may perform measurement(s) and/or may detect CH. The Rx WTRU may report and/or feedback CH. This may include SCI, SL MAC CE, and/or SL RRC.

WTRU may indicate a set and/or subset of WTRUs S3 for transmitting PSSCH based on detected and/or reported CH. S3 may be less than and/or equal to S2. This may be dynamic, semi-static, and/or may be done via Tx WTRU, Rx WTRU, and/or joint determined by Tx WTRU and Rx WTRU. Additionally or alternatively, this may be done via another WTRU and/or a coordinating WTRU. S3 may be determined based on CH condition detected and/or reported by Rx WTRU, Tx WTRU, and/or combination of Rx WTRU and Tx WTRU. t

For example, a transmit WTRU (e.g., WTRU B 1102) may transmit (e.g., via groupcast) PSSCH to one or more of: WTRU set S1 (e.g., 1104); WTRU set S2 (e.g., 1106); WTRU set S3 (e.g., WTRU_K-1 1108; and/or WTRU_K (e.g., 1110).

Based on criteria (e.g., reliability, coverage, latency, performance, data rate, quality of service (QOS)), S1, S2, and/or S3 may be dynamically decided and/or semi-statically determined. Indication may be via SL MAC CE, L1-SCI, and/or SL RRC, for example, based on the latency requirement(s).

For example, S1 may be Rx WTRU group and/or set for groupcast reception. S2 may be Tx WTRU group and/or set for transmission of PSSCH. S3 may be the actual Tx WTRU group and/or set for performing precoded and/or beamformed PSSCH. S3 may be less than and/or equal to S2. S1 may be the same or different than S2. For example, S1 and S2 may be one or more (e.g., all) K WTRUs, and/or S3 may be M WTRUs (e.g., a subset of K WTRUs) where M<K. For example, S1 and S2 may be configured and/or S3 may be indicated; S3 may be a subset of S2.

The Tx WTRU may adapt the transmission format (e.g., PSSCH formats) based on CH conditions. This may be explicit indication via SL MAC CE, SCI, and/or RRC. Additionally or alternatively, this may be done using implicit indication via association between detected and reported CH conditions and/or PSSCH formats.

For SL, WTRU methods and/or procedures for SL CH mode may be developed. A WTRU may be (pre) configured with a group of WTRUs for PSSCH Rx (Set 1 configuration). Additionally or alternatively, a WTRU may be (pre) configured with a group of WTRUs for PSSCH Tx (set S2 configuration). A WTRU may be (pre) configured with a PSSCH configuration and/or SL DM-RS configuration.

A WTRU may perform measurement and/or detection for CH condition(s) based on SL CH-RS configuration(s). A WTRU may report and/or feedback CH condition(s). A WTRU may be indicated with a simultaneous group of WTRUs for PSSCH Tx (e.g., set S3) based on detected and/or reported CH condition(s). A WTRU may compare CH measurement with a CH threshold. If CH is not soft (e.g., CH is hard), the WTRU may maintain the S1, S2, and/or S3 sizes. If CH condition is soft (e.g., CH is not hard), the WTRU may be indicated to increase the S3 size (to increase the degree of CH and/or make it harder for CH condition). After increase of S3 size, the WTRU may (e.g., further) compare CH measurement with a CH threshold. If CH condition is hard, the WTRU may maintain the S1, S2, and/or S3 sizes. If CH condition is not hard or soft, the WTRU may be re-configured with a group of WTRUs for PSSCH Tx (Set S2 configuration). After reconfiguration for a group of UEs for PSSCH Tx and/or set S2 configuration, the WTRU may (e.g., again) compare the CH measurement with a threshold. If CH condition is not hard or soft, the WTRU may be re-configured with a group of UEs for PSSCH Rx (Set 1 configuration). The WTRU may maintain the S1, S2, and/or S3 sizes. If CH condition is hard, the WTRU may maintain the S1, S2, and/or S3 sizes. The WTRU may transmit PSSCH via a cast type (e.g., groupcast with Set S1 for the first hop and/or current hop in SL mesh network). The WTRU may transmit PSSCH with PSSCH format associated with the detected and/or reported CH condition via another cast type (e.g., unicast with Set S3 for the second hop and/or next hop in SL mesh network). The first and second cast types in the first and second hops respectively may be the same or different during different hops in SL mesh network.

When channel is hardening, the gNB may reconfigure the DM-RS configuration and/or the WTRU may determine the PDSCH DM-RS being mapped to physical resources according to configuration type (e.g., 3, 4) as given by the higher-layer parameter DM-RS type in DMRS-DL configuration for a PDSCH configuration.

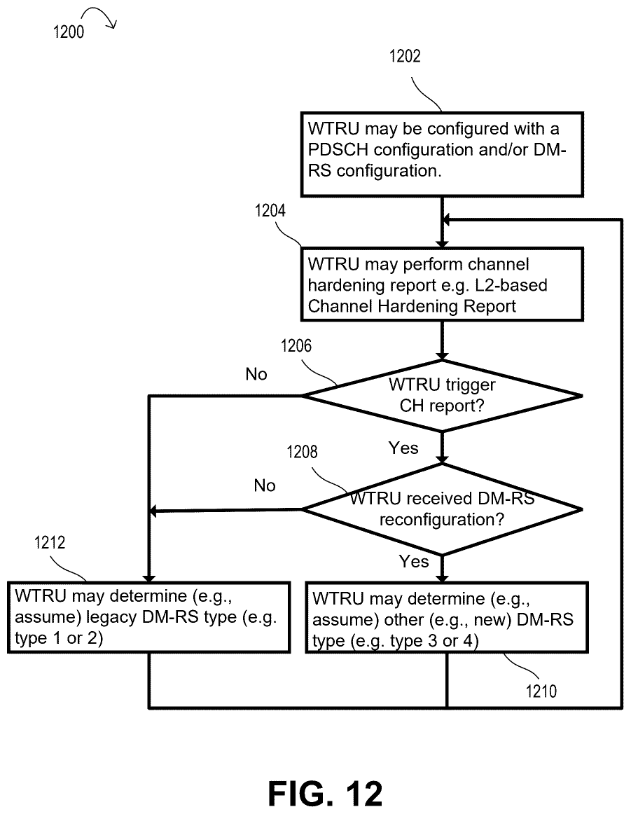

FIG. 12 depicts an example WTRU procedure for DM-RS density reduction when channel is hardening 1200. A WTRU may perform PDCCH SS switching during channel hardening. At 1202, a WTRU may be configured with a PDSCH configuration and/or DM-RS configuration. At 1204, a WTRU may perform channel hardening report (e.g., L2-based Channel Hardening Report). At 1206, a WTRU may determine whether to trigger CH report. If the WTRU determines to trigger CH report (e.g., at 1208), the WTRU may determine whether the WTRU received DM-RS reconfiguration. If the WTRU received DM-RS reconfiguration and determines that to trigger a CH report, the WTRU may determine (e.g., at 1210) another (e.g., new) DM-RS type (e.g., type 3, type 4). If the WTRU determines to not trigger a CH report, the WTRU (e.g., at 1212) may determine (e.g., legacy) DM-RS type (e.g., type 1, type 2). If the WTRU determines to trigger a CH report and the WTRU did not receive DM-RS reconfiguration, the WTRU may (e.g., at 1212) determine (e.g., legacy) DM-RS type (e.g., type 1, type 2).

A WTRU can be configured with one or more (e.g., multiple) SSSG for indication of CH. For example, the WTRU can be configured with at least two SSSGs (e.g., one SSSG may be used when the WTRU is no CH (default SSSG), the other SSSG may be used when WTRU is in channel hardening).

The WTRU may be signaling with SS space set switching. The WTRU may switch to its in-(CH) SS/SSSG with limited aggregation levels. The activation and/or switching of SS/SSSG can be done as the part of handshaking signaling of channel hardening report between gNB and WTRU via DCI and/or MAC-CE. For example, the WTRU may switch to a SS group with AL {2, 4} and/or a SS group with ALs {2, 4, 8}. One out of every N PDCCH monitoring occasions and/or based on a timer, a WTRU may switch back to the default SSSG (no-CH SSSG) to perform PDCCH monitoring.

A WTRU may perform CH monitoring and/or the WTRU may fall back to the default SSSG (no CH) when CH condition changes. Additionally or alternatively, the gNB can indicate to the WTRU to monitor the default SS and/or stop monitoring other CH SSSG (e.g., at any time).

A WTRU procedure for aperiodic trigger-based (e.g., L2-MAC-CE) may be described herein. A WTRU may perform (L1) CH measurement based on configured RS(s) (e.g., CSI-RS resources). CH measurement configuration may be similar to L1-based CH measurement. For example, the WTRU may be configured with (e.g., periodic) RS resources for monitoring L1-based CH measurement. A WTRU may determine whether CH (e.g., CH condition) is detected. The determination of the CH condition may be based on a CH metric. The CH metric may include an effective delay spread and/or an effective channel gain. The CH condition may be based on a deviation of the effective channel gain in accordance with the CH measurement configuration information. The CH condition may be based on a determination that the effective delay spread is less than a threshold (e.g., included in the CH measurement configuration information). For example, the threshold may be (pre) configured and/or (pre) defined. For example, the threshold may be dynamically configurable (e.g., to allow flexibility). If the WTRU detects CH may (e.g., need to) be adjusted, the WTRU may trigger a reporting. The CH feedback change detection (e.g., from CH to no CH) at the WTRU may be a L1/L2 combined procedure, where L1 performs the physical (PHY) layer measurement and L2 decides the triggering of CH condition change(s). For example, when PHY layer/L1 detects a L1 CH measurement above a pre-defined threshold ε₀, the PHY layer may trigger a CH feedback indication (CFI) and may send it to the L2 (MAC). For example, the MAC layer may start a timer as soon as it receives CFI, and/or it may keep incrementing the counter by 1 for every CFI instance. When the counter of CFI exceeds the maximum value before the timer expires, for example, the MAC may trigger CH feedback change (CFC) and/or may start the change procedure. A WTRU may transmit the CH change message on PRACH, PUSCH, and/or PUCCH. The WTRU may report CH feedback (e.g., X bits) via PRACH, PUCCH, and/or PUSCH; and/or the WTRU may report CH feedback with RSRP via PRACH, PUCCH, and/or PUSCH. A WTRU may receive a CH feedback change response (CFCR) message from the gNB (e.g., as an acknowledgement). The WTRU may be indicated to stop monitoring L2-based CH triggering report by the gNB. If the WTRU is configured with periodic CH report, for example, the WTRU may stop to monitor periodic RS for CH detection.

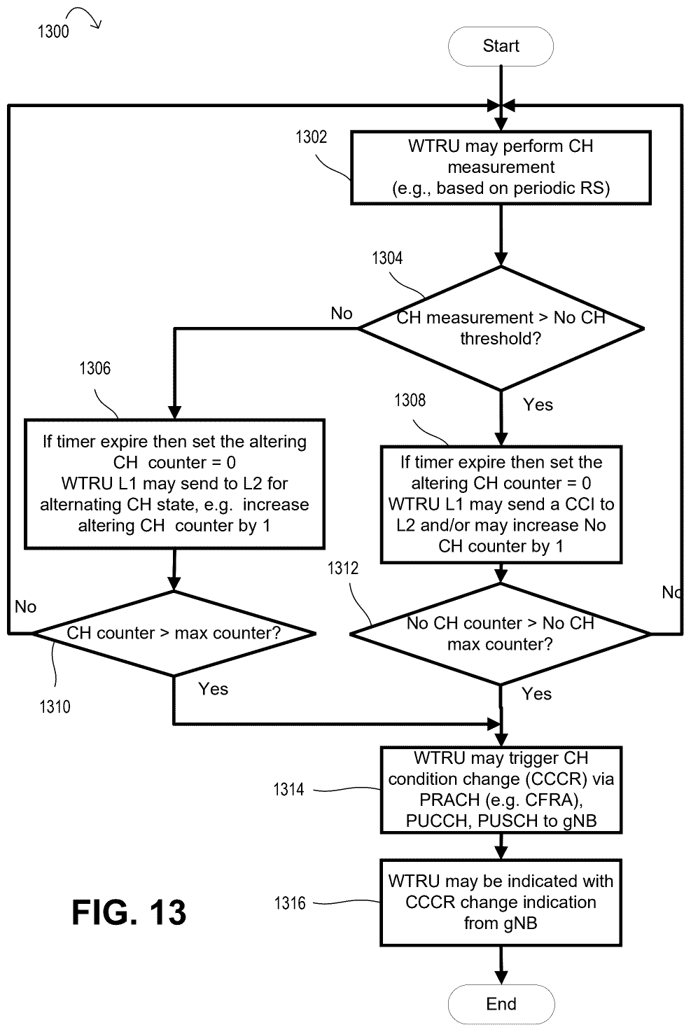

FIG. 13 depicts a flow chart for aperiodic trigger-based approach with L2 MAC-CE for CH. At 1302, a WTRU may perform CH measurement (e.g., based on periodic RS). At 1304, a WTRU may determine if the CH measurement is greater than a threshold (e.g., “No CH” threshold). The No CH threshold may be energy-based threshold. The No CH counter may be a counter that counts the number of CHIs. At 1308, if the CH measurement is greater than a threshold (e.g., No CH threshold), and if the timer is expired, the altering CH counter may be set to 0 (e.g., CH counter=0) and/or the WTRU L1 may send a CCI to L2 and/or may increase the No CH counter by 1. At 1306, if the CH measurement is not greater than a threshold (e.g., No CH threshold), and if the timer is expired, the altering CH counter may be set to 0 (e.g., CH counter=0) and/or the WTRU L1 may send to L2 for alternating CH state (e.g., increase altering CH counter by 1). At 1308, the WTRU may determine if the No CH counter is greater than a maximum number (e.g., No CH counter). If the CH counter is greater than a No CH max counter, then the WTRU may (e.g., at 1314) trigger CH condition change (CCCR) via PRACH (e.g., CFRA), PUCCH, and/or PUSCH to gNB. At 1316, the WTRU may be indicated with CCCR change indication from the gNB. At 1312, if the CH counter is not greater than a max counter (e.g., No CH max counter), then the WTRU may perform CH measurement (e.g., at 1302) and/or may repeat procedures 1304 and/or 1308 (e.g., as described herein.

When channel is hardening, the WTRU sets and/or group sets may be reconfigured and/or the WTRU can determine the PSCCH format that may be adapted according to detected and/or reported CH conditions. MIMO SL operations may be based on detected and/or reported CH and/or MIMO SL format adaptation may be performed.

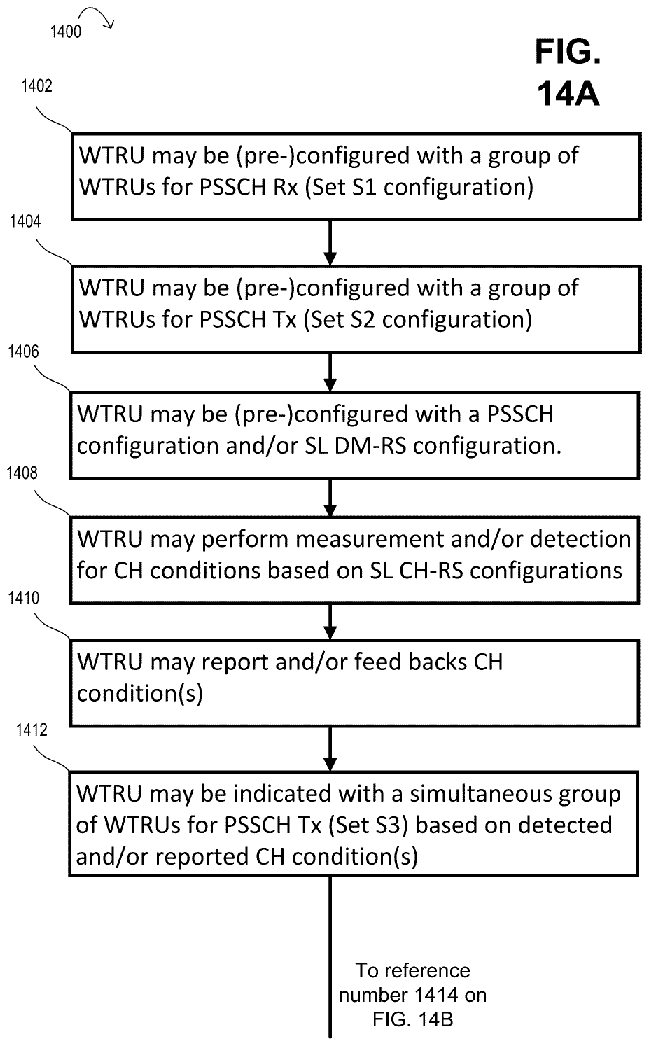

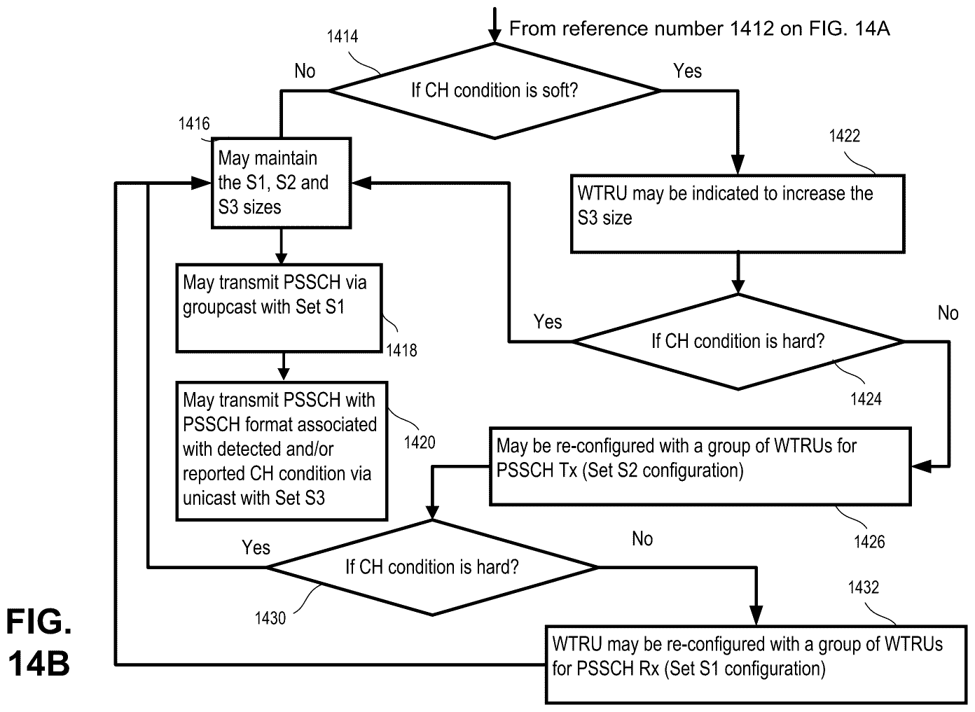

FIGS. 14A and 14B depict an exemplary flow chart for WTRU methods and/or procedures for SL CH mode. At 1402, a WTRU may be (pre)-configured with one or more of the following. The WTRU may be (pre) configured with a group of WTRUs for PSSCH Rx (Set S1 configuration). Additionally or alternatively, at 1404, the WTRU may be (pre)-configured with a group of WTRUs for PSSCH Tx (Set S2 configuration). At 1406, the WTRU may be (pre)-configured with a PSSCH configuration and/or SL DM-RS configuration.

At 1408, the WTRU may perform measurement and/or detection for CH conditions (e.g., as described herein), for example, based on SL CH-RS configurations. At 1410, the WTRU may report and/or feed back CH condition(s). At 1412, the WTRU may be indicated with a simultaneous group of WTRUs for PSSCH Tx (e.g., Set S3) based on detected and/or reported CH condition(s).

At 1414, the WTRU may compare CH measurement with a CH threshold. If CH condition is not soft (e.g., channel is hard), the WTRU may maintain the S1, S2, and/or S3 sizes. At 1422, if the CH condition is soft, the WTRU may be indicated to increase the S3 size. At 1424, the WTRU may (e.g., further) compare CH measurement with a CH threshold. At 1416, if the CH condition is hard, the WTRU may maintain the S1, S2, and/or S3 sizes. At 1426, if the CH condition is not hard (e.g., soft), the WTRU may be re-configured with a group of WTRUs for PSSCH Tx (Set S2 configuration).

After reconfiguration for a group of WTRUs for PSSCH Tx or Set S2 configuration, the WTRU may (e.g., again) compare (e.g., at 1430) the CH measurement with a CH threshold. At 1432, if the CH condition is not hard (e.g., soft), the WTRU may be re-configured with a group of WTRUs for PSSCH Rx (Set S1 configuration). The WTRU may maintain the S1, S2 and S3 sizes (e.g., at 1416). At 1416, if CH condition is hard, the WTRU may maintain the S1, S2 and S3 sizes. At 1418, the WTRU may transmit PSSCH via a cast type (e.g., groupcast with Set S1 for the first hop and/or current hop in sidelink mesh network). At 1420, the WTRU may transmit PSSCH with PSSCH format associated with the detected and/or reported CH condition via another cast type (e.g., unicast with Set S3 for the second hop and/or next hop in sidelink mesh network). The first and second cast types in the first and second hops correspondingly may be the same or different during different hops in sidelink mesh network (e.g., as described herein).

### ABBREVIATIONS AND ACRONYMS

ACK Acknowledgement
BLER Block Error Rate
BWP Bandwidth Part
CAP Channel Access Priority
CAPC Channel access priority class
CCA Clear Channel Assessment
CCE Control Channel Element
CE Control Element
CG Configured grant or cell group
CP Cyclic Prefix
CP-OFDM Conventional OFDM (relying on cyclic prefix)
CQI Channel Quality Indicator
CRC Cyclic Redundancy Check
CSI Channel State Information
CW Contention Window
CWS Contention Window Size
CO Channel Occupancy
DAI Downlink Assignment Index
DCI Downlink Control Information
DFI Downlink feedback information
DG Dynamic grant
DL Downlink
DM-RS Demodulation Reference Signal
DRB Data Radio Bearer
eLAA enhanced Licensed Assisted Access
FeLAA Further enhanced Licensed Assisted Access
HARQ Hybrid Automatic Repeat Request
LAA License Assisted Access
LBT Listen-Before-Talk
LTE Long Term Evolution e.g. from 3GPP LTE R8 and up
NACK Negative ACK
MCS Modulation and Coding Scheme
MIMO Multiple Input Multiple Output
NR New Radio
OFDM Orthogonal Frequency-Division Multiplexing
PHY Physical Layer
PID Process ID
PO Paging Occasion
PRACH Physical Random Access Channel
PSS Primary Synchronization Signal
PSCCH Physical Sidelink Control Channel
PSSCH Physical Sidelink Share Channel
RA Random Access (or procedure)
RACH Random Access Channel
RAR Random Access Response
RCU Radio access network Central Unit
RF Radio Front end
RLF Radio Link Failure
RLM Radio Link Monitoring
RNTI Radio Network Identifier
RO RACH occasion
RRC Radio Resource Control
RRM Radio Resource Management
RS Reference Signal
RSRP Reference Signal Received Power
RSSI Received Signal Strength Indicator
SCI Sidelink Control Information
SL Sidelink
SDU Service Data Unit
SRS Sounding Reference Signal
SS Synchronization Signal
SSS Secondary Synchronization Signal
SWG Switching Gap (in a self-contained subframe)
SPS Semi-persistent scheduling
SUL Supplemental Uplink
TB Transport Block
TBS Transport Block Size
TRP Transmission/Reception Point
TSC Time-sensitive communications
TSN Time-sensitive networking
UL Uplink
URLLC Ultra-Reliable and Low Latency Communications
WBWP Wide Bandwidth Part
WLAN Wireless Local Area Networks and related technologies (IEEE 802.xx domain)

1. A wireless transmit/receive unit (WTRU) comprising:
a processor configured to:
receive channel hardening (CH) measurement configuration information and CH reporting configuration information, wherein the CH measurement configuration information comprises one or more of a set of reference signals, a CH metric, one or more parameters associated with the CH metric, or one or more thresholds associated with the CH metric, and wherein the CH reporting configuration information comprises one or more of a reporting period, a number of sub-bands to report, or whether the CH report is to comprise the CH condition over a narrow-beam or a wide-beam;
determine whether a CH condition has occurred based on one or more measurements and based on the CH measurement configuration information;
send a CH report based on the CH reporting configuration information, wherein the CH report comprises an indication of whether the CH condition has occurred, and
apply a transmission or a reception format associated with CH condition.

2. The WTRU of claim 1, wherein the CH report is sent based on a determination that the CH condition meets a criterion associated with the CH metric, the one or more parameters associated with the CH metric, or the one or more thresholds associated with the CH metric.

3. The WTRU of claim 1, wherein the processor is configured to receive a set of transmission or reception configuration information associated with the CH condition, wherein the set of transmission or reception configuration comprises one or more of a set of data channel configurations, a set of control channel configuration, a set data channel formats, or channel state information (CSI) reporting configuration information.

4. The WTRU of claim 3, wherein the processor is configured to:
on a condition that the WTRU is configured with an autonomous mode, autonomously activate one or more reception or transmission configurations comprised, in the set of reception or transmission configuration information, for one or more subsequent receptions or transmissions;
on a condition that the WTRU is not configured with the autonomous mode, send an indication of supported one or more reception or transmission configurations to a network node; and
apply a network-indicated reception or transmission configuration based on an indication by the network node.

5. The WTRU of claim 1, wherein processor is configured to:
measure one or more variations of channel gains using a CH metric to determine the one or more measurements, or
measure coherence bandwidth or delay spread to determine the one or more measurements.

6. The WTRU of claim 1, wherein the reporting configuration indicates that the CH report should be sent via one or more of a medium access control (MAC) control element (CE), a layer one (L1) signaling message, a radio resource control (RRC) message, a sidelink (SL) MAC-CE, a SL-L1 signaling message, or a SL-RRC message; and
wherein the CH report comprises one or more of: the determined CH condition for each configured sub-band, or the determined CH condition of the measured wideband or narrow-band.

7. The WTRU of claim 1, wherein the CH condition comprises a positive CH condition or a negative CH condition, wherein the transmission format comprises a first transmission format and a second transmission format, wherein the reception format comprises a first reception format and a second transmission format, and wherein the processor is configured to apply the first transmission or the first reception format based at least on the positive CH condition, and wherein the processor is configured to apply the second transmission or the second reception format based at least on the negative CH condition.

8. The WTRU of claim 7, wherein the processor is configured to reduce a demodulation reference signal (DM-RS) density, associated with time or frequency, based on a determination that the CH condition comprises the positive CH condition.

9. The WTRU of claim 7, wherein the processor is configured to apply a first set of one or more search spaces based on the positive CH condition, and wherein the processor is configured to apply a second set of one or more search spaces based on the negative CH condition.

10. The WTRU of claim 7, wherein the determination of the CH condition is based on a CH metric, wherein the CH metric comprises an effective delay spread or an effective channel gain, and wherein the CH condition is based on a deviation of the effective channel gain in accordance with the CH measurement configuration information, or wherein the CH condition is based on a determination that the effective delay spread is less than a threshold comprised in the CH measurement configuration information.

11. The WTRU of claim 10, wherein the positive CH condition comprises the effective delay spread or effective channel gain, in a time domain or a frequency domain, below the threshold comprised in the CH measurement configuration information, and wherein the negative CH condition comprises the effective delay spread or the effective channel gain, in the time domain or the frequency domain, equal to or greater than a threshold comprised in the CH measurement configuration information.

12. The WTRU of claim 1, wherein the processor being configured to send the CH report comprises the processor being configured to send an indication that the CH condition has changed.

13. The WTRU of claim 1, wherein the processor is configured to send the CH report aperiodically based on one or more of layer 2 (L2)-medium access control (MAC) control entity (CE), radio resource control (RRC), or downlink control information (DCI).

14. The WTRU of claim 13, wherein the CH report is sent during a configured periodic or semi-persistent time window or duration.

15. A method performed by a wireless transmit/receive unit (WTRU), the method comprising:
receiving channel hardening (CH) measurement configuration information and CH reporting configuration information, wherein the CH measurement configuration information comprises one or more of a set of reference signals, a CH metric, one or more parameters associated with the CH metric, or one or more thresholds associated with the CH metric, and wherein the CH reporting configuration information comprises one or more of a reporting period, a number of sub-bands to report, or whether the CH report is to comprise the CH condition over a narrow-beam or a wide-beam;
determining whether a CH condition has occurred based on one or more measurements and based on the CH measurement configuration information;
sending a CH report based on the CH reporting configuration information, wherein the CH report comprises an indication of whether the CH condition has occurred, and
applying a transmission or a reception format associated with CH condition.

16. The method of claim 15, wherein the CH report is sent based on a determination that the CH condition meets a criterion associated with the CH metric, the one or more parameters associated with the CH metric, or the one or more thresholds associated with the CH metric.

17. The method of claim 15, further comprising receiving a set of transmission or reception configuration information associated with the CH condition, wherein the set of transmission or reception configuration comprises one or more of a set of data channel configurations, a set of control channel configuration, a set data channel formats, or channel state information (CSI) reporting configuration information.

18. The method of claim 17, further comprising:
autonomously activating one or more reception or transmission configurations comprised, in the set of reception or transmission configuration information, for one or more subsequent receptions or transmissions when the WTRU is configured with an autonomous mode.

19. The method of claim 17, further comprising:
sending an indication of supported one or more reception or transmission configurations to a network node when the WTRU is not configured with the autonomous mode.

20. The method of claim 17, further comprising applying a network-indicated reception or transmission configuration based on an indication by the network node.

21. The method of claim 15, further comprising:
measuring one or more variations of channel gains using a CH metric to determine the one or more measurements, or
measuring coherence bandwidth or delay spread to determine the one or more measurements.

22. The method of claim 15, wherein the reporting configuration indicates that the CH report should be sent via one or more of a medium access control (MAC) control element (CE), a layer one (L1) signaling message, a radio resource control (RRC) message, a sidelink (SL) MAC-CE, a SL-L1 signaling message, or a SL-RRC message; and
wherein the CH report comprises one or more of: the determined CH condition for each configured sub-band, or the determined CH condition of the measured wideband or narrow-band.

23. The method of claim 15, wherein the CH condition comprises a positive CH condition or a negative CH condition, wherein the transmission format comprises a first transmission format and a second transmission format, wherein the reception format comprises a first reception format and a second transmission format, and wherein the processor is configured to apply the first transmission or the first reception format based at least on the positive CH condition, and wherein the processor is configured to apply the second transmission or the second reception format based at least on the negative CH condition.

24. The method of claim 23, further comprising reducing a demodulation reference signal (DM-RS) density, associated with time or frequency, based on a determination that the CH condition comprises the positive CH condition.

25. The method of claim 23, further comprising applying a first set of one or more search spaces based on the positive CH condition, and applying a second set of one or more search spaces based on the negative CH condition.

26. The method of claim 23, wherein the determination of the CH condition is based on a CH metric, wherein the CH metric comprises an effective delay spread or an effective channel gain, and wherein the CH condition is based on a deviation of the effective channel gain in accordance with the CH measurement configuration information, or wherein the CH condition is based on a determination that the effective delay spread is less than a threshold comprised in the CH measurement configuration information.

27. The method of claim 26, wherein the positive CH condition comprises the effective delay spread or effective channel gain, in a time domain or a frequency domain, below the threshold comprised in the CH measurement configuration information, and wherein the negative CH condition comprises the effective delay spread or the effective channel gain, in the time domain or the frequency domain, equal to or greater than a threshold comprised in the CH measurement configuration information.

28. The method of claim 15, wherein sending the CH report comprises sending an indication that the CH condition has changed.

29. The method of claim 15, wherein the CH report is sent aperiodically based on one or more of layer 2 (L2)-medium access control (MAC) control entity (CE), radio resource control (RRC), or downlink control information (DCI).

30. The method of claim 13, wherein the CH report is sent during a configured periodic or semi-persistent time window or duration.
